(19) United States
(12) Patent Application Publication
(10) Pub. No.: US 2026/0223242 A1
(43) Pub. Date: Jul. 30, 2026

(54) CELL DISCONTINUOUS TRANSMISSION (DTX)-DISCONTINUOUS RECEPTION (DRX) MECHANISM

(71) Applicant: Intel Corporation, Santa Clara, CA (US)

(72) Inventors: Toufiqul Islam, Santa Clara, CA (US); Daewon Lee, Portland, OR (US); Seau Sian Lim, Swindon SWD (GB); Youn Hyoung Heo, Sunnyvale, CA (US); Hui Ma, Kanata (CA); Sudeep Palat, Cheltenham, Gloucestershire (GB)

(21) Appl. No.: 19/145,355

(22) PCT Filed: Dec. 27, 2023
(86) PCT No.: PCT/US2023/086072

§ 371 Date: Jul. 2, 2025

Related U.S. Application Data
(60) Provisional application No. 63/483,457, filed on Feb. 6, 2023.

(51) Int. Cl. H04W 76/28; H04L 5/00; H04W 72/231

(52) U.S. Cl. CPC H04W 76/28; H04L 5/0051; H04W 72/231

(57) ABSTRACT

Various embodiments herein provide techniques related to a user equipment (UE). The UE may be configured to identify an indication related to transmission or reception activity of a cell of a cellular network during a non-active duration of the cell that is related to cell discontinuous transmission (DTX) or cell discontinuous reception (DRX). The UE may further be configured to monitor, based on the indication, for receipt of a signal. Other embodiments may be described and/or claimed.

### CROSS REFERENCE TO RELATED APPLICATION

The present application claims priority to U.S. Provisional Patent Application No. 63/483,457, which was filed Feb. 6, 2023.

### BACKGROUND

Energy consumption may be a major contributor to network operating expenditure. Energy-efficient equipment and/or techniques may provide benefits by helping operators to deal with unpredictable fuel prices, or help operators to conserve power. Compared with fourth generation (4G) networks, fifth generation (5G) or beyond systems may have larger bandwidth, a larger number of transmit/receive (TX/RX) antennas or panels, and higher deployment density for the sake of improving system performance and user experience. As a result, different vendors may implement proprietary solutions to improve or optimize their network energy consumption.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example cell active/non-active duration cycle, in accordance with various embodiments.

FIG. 2 illustrates an alternative cell active/non-active duration cycle, in accordance with various embodiments.

FIG. 3 illustrates an example of alignment of a cell discontinuous transmission (DTX) and discontinuous reception (DRX) active duration, in accordance with various embodiments.

FIG. 4 illustrates examples of a medium access control (MAC) control element (CE) related to cell DTX/DRX, in accordance with various embodiments.

FIG. 5 illustrates further examples of a MAC CE related to cell DTX/DRX, in accordance with various embodiments.

FIG. 6 schematically illustrates a wireless network in accordance with various embodiments.

FIG. 7 schematically illustrates components of a wireless network in accordance with various embodiments.

FIG. 8 is a block diagram illustrating components, according to some example embodiments, able to read instructions from a machine-readable or computer-readable medium (e.g., a non-transitory machine-readable storage medium) and perform any one or more of the methodologies discussed herein.

FIG. 9 illustrates a network in accordance with various embodiments.

FIG. 10 depicts an example procedure for practicing the various embodiments discussed herein.

FIG. 11 depicts another example procedure for practicing the various embodiments discussed herein.

FIG. 12 depicts another example procedure for practicing the various embodiments discussed herein.

FIG. 13 depicts another example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

As previously noted, different vendors of 5G networks may implement proprietary solutions to improve or optimize their network energy consumption. However, such techniques may be limited by lack of feedback from a user equipment (UE) or better coordination between a UE and a base station such as a gNodeB (gNB) so that more information can be available at the gNB to ensure more optimized network energy saving. Solutions such as feedback from the UE or control signaling from the gNB in support of network energy saving may close this gap. One potential enabler for network energy saving is to increase the sleep duration for the base station.

One such mechanism may be the introduction of a Cell discontinuous transmission (DTX) and Cell discontinuous reception (DRX) mechanism as described in the third generation partnership project (3GPP) work item (WI) as follows: “Specify enhancement on cell DTX/DRX mechanism including the alignment of cell DTX/DRX and UE DRX in RRC_CONNECTED mode, and inter-node information exchange on cell DTX/DRX.”

With Cell DTX/DRX, a cell may only be active for a certain time over a cycle and transmission to or reception from UE can be made when the cell is active.

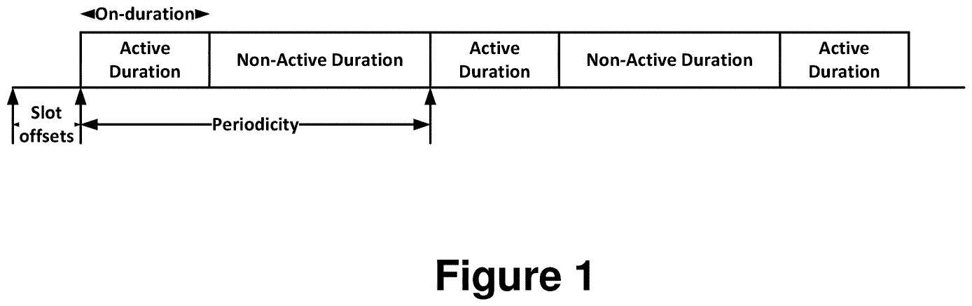

Cell DTX/DRX can be configured via dedicated radio resource control (RRC) message, and the signalling to activate/deactivate can be done by layer 1/layer 2 (L1/L2) signalling or by dedicated RRC message. The L1/L2 signalling may be done via group-common L1 signalling. The Cell DTX/DRX cycle may include an Active duration and a non-Active duration which may be repeated periodically. Cell DTX/DRX configuration information may include elements such as slot offsets, periodicity and on-duration. Active duration can also be referred to as ON-duration of the DTX/DRX cycle. Non-active duration can also be referred to as outside active duration. An example of a cell active/non-active duration cycle is shown in FIG. 1.

Upon the activating of the Cell DTX and Cell DRX by the L1/L2 signalling, the UE operation during the Active duration and non-Active duration may depend on what level of transmissions/receptions are to be allowed during the non-Active duration. The scenarios of transmissions/receptions during the non-Active duration can correspond to the following:
1. No transmissions/receptions in the cell
2. Only allow synchronization block (SSB) transmissions in the cell
3. Only allow SSB and other uplink (UL)/downlink (DL) reference signals (i.e. SSB and channel state information-reference signal (CSI-RS) in the DL and SRS from UEs in the UL in the cell)
4. Transmission/receptions allowed in item 2 or 3 and additionally including periodic data and signalling transmissions/reception related to semi-persistent scheduling (SPS), cell group (CG), scheduling request (SR) and physical random access channel (PRACH) from UEs in the cell
5. Transmission/receptions allowed in item 2 or 3 and/or item 4 and additionally Including DL and UL retransmissions from UEs in the cell.

In UE DRX for UE power saving, similar elements related to active time and non-active/outside active time are defined. During the non-active time, the UE does not monitor the physical downlink control channel (PDCCH) while the CSI reporting is disabled, and periodic and semi-persistent SRS are not transmitted. Similar UE operation may be defined while UE is in non-Active duration in Cell DTX/DRX. In UE DRX, there is only one scenario of transmissions/receptions during the non-active time, and hence only one UE behaviour is defined in the third generation partnership project (3GPP) specifications. For Cell DTX/DRX, it may be beneficial to have more than one behaviour of transmission and receptions during the non-Active duration to allow different levels of network energy saving for a cell of the gNB.

Note also that Cell DTX and Cell DRX can be jointly or separately operated. ‘Jointly,’ as used herein, means that there is no separate configuration for Cell DTX and Cell DRX and their Active duration and non-Active duration are completely aligned. ‘Separately,’ as used herein, means that the configuration for Cell DTX and Cell DRX are separately configured and their Active duration and non-Active duration may not be aligned.

Embodiments herein relate to use of an indication of different levels of transmissions and receptions for a (serving) cell or a group of serving cells (in the carrier aggregation (CA) case) of a gNB (different network energy saving modes or levels) and the corresponding UE operation during the non-Active duration for the different levels while Cell DRX and Cell DRX are jointly operated or separately operated.

Embodiments may enable the network to indicate the level of transmissions/receptions during the non-Active duration either via the dedicated RRC message or the L1/L2 indication and to define the UE operation in the cell corresponding to each level of transmissions/receptions during the non-Active duration.

Typical gNB operation may serve different loading conditions, such as low, moderate, or high load and correspondingly system resource utilization would vary. Under low to medium load conditions, resource utilization is expected to be low, and it may be possible that gNB would have higher chances of inactivity, i.e., no transmission or reception could occur for a certain amount of time, or some transmissions or receptions can be turned off during a certain time period but some transmissions or receptions may still be allowed to continue to meet the UE quality of service (QoS) and radio resource measurement (RRM)/scheduling measurement requirements. To indicate the time a cell of the gNB is in such non-active duration, the Active and non-Active duration cycle may be defined as depicted in FIG. 1.

However, instead of assuming that all transmissions and receptions are turned off during the non-Active duration (as in Level #1 below), in one embodiment the network may indicate to the UE which transmissions and receptions are to be turned off or continued during the non-Active duration of the Cell DTX/DRX. The following table Table 1 contains some illustrations of different example possible levels/combinations of transmissions/receptions (TX/RX) during the non-Active duration (in the order of most network energy saving level (i.e. Level #1) to the least network energy saving level (i.e. Level #5) other than there is no non-Active duration. Other levels with different combinations of transmissions/receptions are not precluded and can be added or substituted as levels in different embodiments. As used in Table 1, a checkmark may indicate successful transmission or reception by a base station such as a gNB, while an “X” may indicate no transmission or reception by the base station.

TABLE 1

| Rx/Tx | | | | | | |
|---|---|---|---|---|---|---|
| occasions in | | | | | | |
| non-Active | | Levels of TX/RX in non-Active duration | | | | |
| duration | 1 | 2 | 3 | 4 | 5 | 6 |
| SPS data and | X | X | X | X | ✓ | ✓ |
| CG data | | | | | | |
| Dynamic | X | X | X | X | X | X |
| scheduling data | | | | | | |
| SR and PRACH | X | X | X | X | ✓ | ✓ |
| UL reference | X | X | X | ✓ | X | ✓ |
| signal: SRS | | | | | | |
| DL reference | X | ✓ | ✓ | ✓ | ✓ | ✓ |
| signals: SSB | | | | | | |
| DL reference | X | ✓ | X | ✓ | X | X |
| signals: CSI-RS | | | | | | |
| and/or TRS | | | | | | |
| DL/UL | X | X | X | X | ✓ | ✓ |
| Retransmissions | | | | | | |

Note that the term “level of transmissions and receptions in the non-Active duration” may be defined in other ways in other embodiments, e.g., NES (Network Energy Saving) modes, modes of NES, NES levels, levels of NES etc.

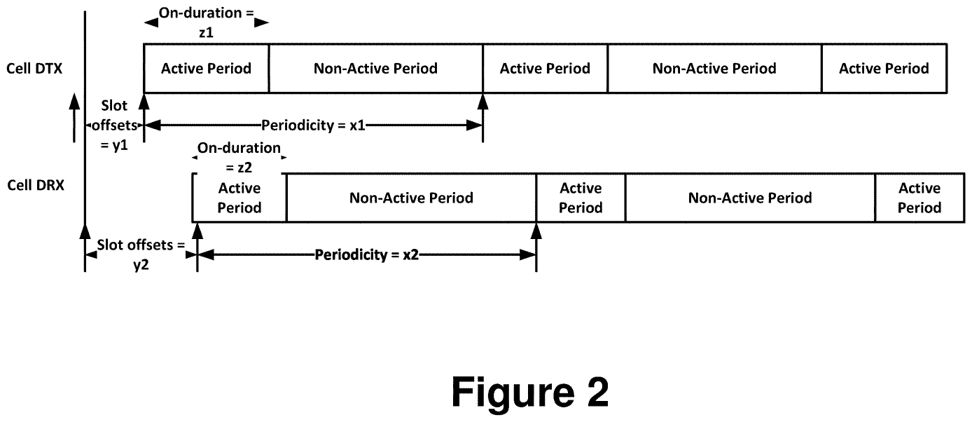

In this embodiment, one way of providing an indication to the UE related to the level of transmissions/receptions in non-Active duration is to signal it in the dedicated RRC signalling as part of the Cell DTX/DRX configuration for a cell or a group of cells (in the carrier aggregation (CA) case that applies the same Cell DTX/DRX configuration). Once the Cell DTX/DRX configuration is enabled via higher layer signalling such as RRC signalling or via L1/L2 signalling, the level of transmission/receptions for the UEs to assume in the non-Active duration will be based on the level configured as part of the Cell DRX/DRX configuration. In the case of multiple Cell DTX/DRX configurations, each corresponding level may be provided for each Cell DTX/DRX configuration and when UE is enabled via RRC signalling or L1/L2 signalling with the configuration index, the corresponding level of transmissions/receptions in non-Active duration is applied. Alternatively, one or multiple level(s) of transmissions/receptions in non-Active duration may be separately configured (i.e. not as part of the Cell DTX/DRX configuration) and one level of transmission/reception may be enabled via dedicated RRC signalling or L1/L2 signalling when a Cell DTX/DRX configuration is enabled. As another embodiment, different levels of transmissions and receptions of the non-Active duration can be configured for Cell DTX and for Cell DRX separately, an example of which is depicted in FIG. 2, and so different levels may be configured and signalled for a UE or UEs in the cell for Cell DTX and for Cell DRX configuration via the RRC signalling or L1/L2 signalling.

As part of the embodiment, the network will select a level of TX/RX during a non-Active duration for a serving cell based on the quality of service (QoS) requirement and the radio resource management (RRM)/scheduling measurement requirements of the UEs in the serving cell. For example, Level #1 may be selected for the case where the UEs in the cell have services that are delay tolerant and RRM/scheduling measurement requirements can be relaxed as the UEs are all indicating that it is in slow mobility. Level #2/Level #3 may be selected for the case where the UEs in the cell have services that are delay-tolerant but requires more stringent RRM/scheduling measurement requirements due to UEs moving. Level #4 is similar to Level #2, except that Uplink measurement over SRS is also required. Level #5 may be selected for the case where the UEs in the cell have services that are more real-time services due to the need of supporting CG and SPS and more stringent user plane latency is required by the UEs. Level #6 is similar to Level #5, except that Uplink measurement over SRS is also required. Assistance information related to the UE mobility may be provided. The criteria of whether relaxed RRM/radio link monitoring (RLM)/beam failure detection (BFD) measurement can be adopted may be reused for this purpose.

Upon receiving the configuration and enabling indication of level of TX/RX for the non-Active duration, the following table provides examples of the UE behaviour in the non-Active duration for the different levels of TX/RX. For UE behaviour in Active duration, the UE will perform as normal for the transmissions and receptions operation as specified in the 3GPP specs. It will be noted that the below table 2 is one example, and the UE may exhibit additional or alternate behaviours in other embodiments.

TABLE 2

| Level of | |
|---|---|
| TX/RX | |
| in non- | |
| Active | |
| duration | UE behaviour in non-Active duration |
| 1 | For Cell DTX |
| | 1. The UE stops monitoring the PDCCHs for new UL and DL |
| | transmissions (no dynamic grant/assignment for new |
| | transmission) and trigger of aperiodic SRS and aperiodic |
| | CSI-RS. Retransmission is separately discussed in (A). |
| | 2. SPS occasions are ignored by the UE (if configured |
| | with SPS). Retransmission is separately discussed in (A). |
| | 3. SSB occasions and periodic/semi-persistent CSI-RS |
| | occasions are assumed to be not present by the UE |
| | for RRM and scheduling measurements. |
| | For Cell DRX: |
| | 1. The UE stops transmitting the periodic/semi persistent SRS. |
| | 2. CG occasions are ignored by the |
| | UE (if configured with CG), except |
| | for retransmission (to be discussed separately in (A)). |
| | 3. SR and PRACH occasions are ignored |
| | by the UE. For pending SR and |
| | initiated PRACH, see (B) and (C) |
| 2 | For Cell DTX |
| | 1. The UE stops monitoring the PDCCHs for new |
| | UL and DL transmissions (no dynamic |
| | grant/assignment for new transmission) and |
| | trigger of aperiodic SRS and aperiodic CSI-RS. |
| | Retransmission is separately discussed in (A). |
| | 2. SPS occasions are ignored by the |
| | UE (if configured with SPS). |
| | Retransmission is separately discussed in (A). |
| | For Cell DRX: |
| | 1. The UE stops transmitting the periodic/semi |
| | persistent SRS. |
| | 2. CG occasions are ignored by the UE |
| | (if configured with CG), except |
| | for retransmission (to be discussed separately in (A)). |
| | 3. SR and PRACH occasions are ignored |
| | by the UE. For pending SR and |
| | initiated PRACH, see (B) and (C). |
| 3 | For Cell DTX |
| | 1. The UE stops monitoring the PDCCHs for new |
| | UL and DL transmissions (no dynamic grant/ |
| | assignment for new transmission and |
| | trigger of aperiodic SRS and aperiodic CSI-RS. |
| | Retransmission is separately discussed in (A). |
| | 2. SPS occasions are ignored by the UE |
| | (if configured with SPS). |
| | Retransmission is separately discussed in (A). |
| | 3. The periodic/semi-persistent CSI-RS occasions |
| | are assumed to be not present by the UE |
| | for RRM and scheduling measurements. |
| | For Cell DRX: |
| | 1. The UE stops transmitting the periodic/ |
| | semi persistent SRS. |
| | 2. CG occasions are ignored by the UE |
| | (if configured with CG), except |
| | for retransmission (to be discussed separately in (A)). |
| | 3. SR and PRACH occasions are ignored |
| | by the UE. For pending SR and |
| | initiated PRACH, see (B) and (C) |
| 4 | For Cell DTX |
| | 1. The UE stops monitoring the PDCCH for new |
| | transmissions (no dynamic grant/assignment for |
| | new transmission, no aperiodic SRS and |
| | CSI-RS). Retransmission is separately discussed in (A). |
| | 2. SPS occasions are ignored by the |
| | UE (if configured with SPS). |
| | Retransmission is separately discussed in (A). |
| | For Cell DRX: |
| | 1. CG occasions are ignored by the UE |
| | (if configured with CG), except |
| | for retransmission (to be discussed separately in (A)). |
| | 2. SR and PRACH occasions are ignored |
| | by the UE. For pending SR and |
| | initiated PRACH, see (B) and (C). |
| 5 | For Cell DTX |
| | 1. The UE stops monitoring the PDCCH for new |
| | transmissions (no dynamic grant/assignment for |
| | new transmission, no aperiodic SRS and |
| | CSI-RS). Retransmission is separately discussed in (A). |
| | 3. Periodic/semi-persistent CSI-RS occasions |
| | are assumed to be not present by the |
| | UE for RRM and scheduling measurements. |
| | For Cell DRX: |
| | 1. The UE stops transmitting the |
| | periodic/semi persistent SRS. |
| 6 | For Cell DTX |
| | 1. The UE stops monitoring the PDCCH for new |
| | transmissions (no dynamic grant/assignment for |
| | new transmission, no aperiodic SRS and |
| | CSI-RS). Retransmission is separately discussed in (A). |
| | 3. Periodic/semi-persistent CSI-RS occasions |
| | are assumed to be not present by the UE |
| | for RRM and scheduling measurements. |
| | For Cell DRX: |
| | No restriction in the UL transmissions during |
| | non-Active duration. |

### A. UL and DL Retransmissions

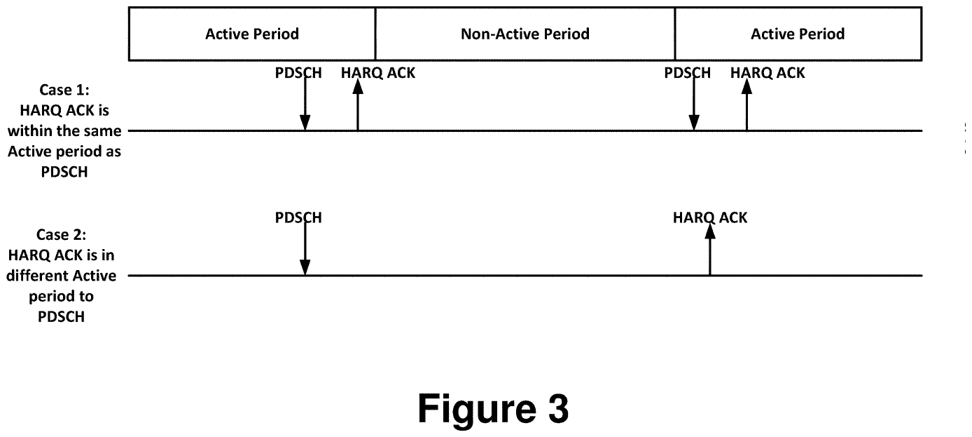

On the retransmissions, in Level 1 to 3, retransmissions, if any, are not scheduled/suspended during the non-Active duration and can be scheduled or resume during the subsequent Active duration(s). FIG. 3 depicts example cases where the Cell DTX and Cell DRX Active duration is aligned.

In both cases, the gNB may take into account of the non-Active duration to allocate the UL resource to carry hybrid automatic repeat request (HARQ) acknowledgement (ACK) feedback corresponding to the physical downlink shared channel (PDSCH) (e.g., the PDSCH-to-HARQ-ACK timing, kl value, physical uplink control channel (PUCCH) or physical uplink shared channel (PUSCH) resource to carry HARQ-ACK feedback etc.). In Case 2, depending on how long the non-Active duration can be, the value for PDSCH-to-HARQ-ACK timing may be extended to accommodate the largest non-Active duration. In the case the Cell DTX and Cell DRX are not aligned, the allocation of PDSCH-to-HARQ-ACK timing value and/or PUCCH/PUSCH resource to carry HARQ-ACK may consider both the non-Active duration and the Active duration of the Cell DRX. For example, HARQ-ACK may only be sent during active duration of cell DRX, which may or may not align with active duration of cell DTX. In another example, if the indicated HARQ-ACK resource falls within the Cell DTX/DRX non-active duration, UE may skip transmission of the HARQ-ACK in that resource. gNB may schedule another resource for HARQ-ACK transmission in subsequent active duration or UE may append HARQ-ACK information with a PUSCH transmission made during subsequent active duration.

For dynamic grant (DG) PUSCH and configured grant (CG) PUSCH, like in normal operation, whether a transmission is successfully received by gNB may depend on whether gNB requests for a retransmission for the HARQ process via dynamic grant. Hence the gNB can request such retransmission during the Active duration. For the case retransmission can be performed via CG (e.g. shared spectrum channel access operation etc.), retransmission will not be performed during non-Active duration since the UE ignores the CG occasions during the duration. However, Configured Grant Retransmission Timer (CGRT) may need to be extended to accommodate the longer time to retransmit. Such configuration changes can be included as part of the Cell DTX/DRX configuration (if needed) or new rule can be specified to allow the counting of the CGRT during Active duration.

Alternative to only retransmit during the next Active duration, similar to UE DRX, each HARQ process with UL/DL retransmission has a HARQ-round trip time (RTT)-Timer (for gNB processing time) and a retransmission timer (for the maximum time for retransmission to occur). The Active duration of the Cell DTX/DRX is extended by the HARQ timers just for the HARQ process. Whenever a transmission/retransmission is performed on a HARQ process (i.e. For downlink (DL), after the HARQ feedback is sent; For uplink (UL), after the PUSCH transmission), the HARQ-RTT-Timer is started. Once HARQ-RTT-Timer expires, the UE starts the retransmission timer. For UL, once a HARQ ACK feedback is received, the UE stops the retransmission timer. Otherwise, the HARQ entity assumes it is successfully transmitted after the retransmission timer expires.

Alternatively, HARQ timers, if running, are terminated when non-active duration starts, I.e., active time is not extended due to ongoing HARQ timers.

### B. Scheduling Request (SR)

For Level #1 to #4, SR occasions in non-Active duration of Cell DRX are ignored by the UE. For pending SR, it will continue in the next valid SR occasions when the cell is in the next Active duration for cell DTX/DRX or Cell DRX.

For Level #5 to #6, SR occasions in non-Active duration of Cell DRX are still available for the UE. UE will continue to use those occasions for pending SR and the scheduling request procedure is the same as normal.

### C. Physical Random Access Channel (PRACH) and Random Access Channel (RACH) Procedure

For Level #1 to #4, PRACH occasions in non-Active duration of Cell DRX may be ignored by the UE.
For PRACH transmission already initiated but no successful response (RAR or MsgB) is received by the UE, UE can either abort the PRACH procedure or continue the reattempt in the next valid PRACH occasions when the cell is the next Active duration in cell DTX/DRX or Cell DRX.
For PRACH transmission already initiated but UE is still in RAR/MsgB window, the UE can either continue to monitor for RAR or MsgB during the non-active duration or abort the PRACH procedure.
If RAR corresponding to the preamble sent in Msg1 is received or ra-ContentionResolutionTimer or msgB-ResponseWindow is running, the UE can either continue to monitor for RAR or MsgB or abort the PRACH procedure.

For Level #5 to #6, PRACH occasions in non-Active duration of Cell DRX are available to the UEs in the cell. Normal operation will continue for UE.

### Interaction Between Cell DRX/DTX and UE DRX.

As both UE DRX and Cell DRX/DTX may be related to whether or when UE receives and/or transmits, there may be a need to coordinate the UE behaviour between UE DRX and Cell DRX/DTX. Because UE DRX may only focus on UE monitoring the PDCCH while Cell DTX/DRX not only covers PDCCH monitoring aspect but also all UL transmissions aspects as well as reference signalling, in one embodiment, Cell DRX/DTX operation may override the UE DRX operation if Cell DRX/DTX is configured or if Cell DRX/DTX is activated and UE DRX is configured (i.e. UE follows the Cell DRX/DTX operation/configuration along with the allowed level of transmissions/receptions whenever it is activated). When network deactivates the Cell DRX/DTX to a UE, the UE switches to UE DRX operation if it is configured. In other words, UEs in the cell follow group-common or cell specific UE DRX configuration, where the parameters of the cell specific DRX configuration of the UE is same as the cell DTX or cell DTX/DRX configuration.

An alternative to this is to align UE DRX of the UEs in the cell with the Active duration of Cell DTX. The different levels of transmission and receptions in the non-Active duration is implemented as exception in the UE DRX operation. For example, in UE DRX off state, SPS data and CG data transmission can still be made in legacy UE DRX operation. However, if either Level #1-#4 is indicated to be used for Cell DTX/DRX, additional restrictions related to SPS and CG can be added to the UE behaviour for UE DRX such that SPS and CG are not considered when UE is not in Active time. In one example of the embodiment, an additional offset can be applied to UE's DRX cycle start position or start of ON-duration-timer when cell DTX/DRX is enabled. This is to align the DRX cycles of different UEs in the cell. The UE specific offset in this case can be mapped to certain cell DTX/DRX configuration.

### L1/L2 Signalling for the Indication on Enabling/Disabling the Cell DTX/DRX and its Corresponding Level of Transmissions and Receptions in the Non-Active Duration

In one embodiment, the configurations of the Cell DTX/DRX (more than 1 Cell DTX/DRX configurations for the case if multiple Cell DTX/DRX can be configured) will be pre-configured to the UE. For the multiple Cell DTX/DRX configuration case, only 1 Cell DTX and/or 1 Cell DRX can be enabled at any one time. The following Table 3 shows example contents for the various cases:

TABLE 3

| | | | Level of TX/RX | |
|---|---|---|---|---|
| | | | in non-active | |
| | | | duration | |
| | | | configured | |
| | | Cell | jointly with Cell | |
| | Single or | DTX/DRX | DTX/DRX | |
| | Multiple Cell | jointly or | configuration or | |
| | DTX/DRX | separately | separately | L1/L2 contents |
| Case | configuration | operated | configured | needed |
| 1 | Single | Jointly | Jointly | 1 enable/disable |
| | | | | bit |
| 2 | Multiple | Jointly | Jointly | 1 Configuration |
| | | | | index |
| | | | | corresponding to |
| | | | | the Cell |
| | | | | DTX/DRX |
| | | | | configuration to |
| | | | | be |
| | | | | enabled/disabled. |
| 3 | Single | Separately | Jointly | 1 enable/disable |
| | | | | bit for Cell DTX |
| | | | | 1 enable/disable |
| | | | | bit of Cell DRX |
| 4 | Single | Separately | Separately | 1 enable/disable |
| | | | | bit for Cell DTX |
| | | | | and 1 Level Index |
| | | | | 1 enable/disable |
| | | | | bit of Cell DRX |
| | | | | and 1 Level Index |
| 5 | Single | Jointly | Separately | 1 enable/disable |
| | | | | bit for Cell |
| | | | | DTX/DRX and 1 |
| | | | | Level Index |
| 6 | Multiple | Separately | Jointly | 1 Configuration |
| | | | | index |
| | | | | corresponding to |
| | | | | the Cell DTX |
| | | | | configuration to |
| | | | | be |
| | | | | enabled/disabled |
| | | | | 1 Configuration |
| | | | | index |
| | | | | corresponding to |
| | | | | the Cell DRX |
| | | | | configuration to |
| | | | | be |
| | | | | enabled/disabled |
| 7 | Multiple | Separately | Separately | 1 Configuration |
| | | | | index |
| | | | | corresponding to |
| | | | | the Cell DTX |
| | | | | configuration to |
| | | | | be |
| | | | | enabled/disabled |
| | | | | and the Level |
| | | | | Index |
| | | | | 1 Configuration |
| | | | | index |
| | | | | corresponding to |
| | | | | the Cell DRX |
| | | | | configuration to |
| | | | | be |
| | | | | enabled/disabled |
| | | | | and the Level |
| | | | | Index |
| 8 | Multiple | Jointly | Separately | 1 Configuration |
| | | | | index |
| | | | | corresponding to |
| | | | | the Cell |
| | | | | DTX/DRX |
| | | | | configuration to |
| | | | | be |
| | | | | enabled/disabled |
| | | | | and 1 Level Index |

For using L1 signalling for the indication, the above L1/L2 contents are in the DCI transmitted in a PDCCH either scrambled with UE specific cell radio network temporary identifier (C-RNTI) or UE group/common radio network temporary identifier (RNTI) for UE group/cell specific. For the latter, the UE group/common RNTI can be provided as part of the Cell DTX/DRX configuration in the dedicated RRC message. The bit width in the downlink control information (DCI) depends on the configurations for Case 1 to 8. For example, if the configuration is Case 1, then only 1 bit is needed in the DCI. However, if the configuration is Case 2, the DCI will need more bits to indicate the Configuration index.

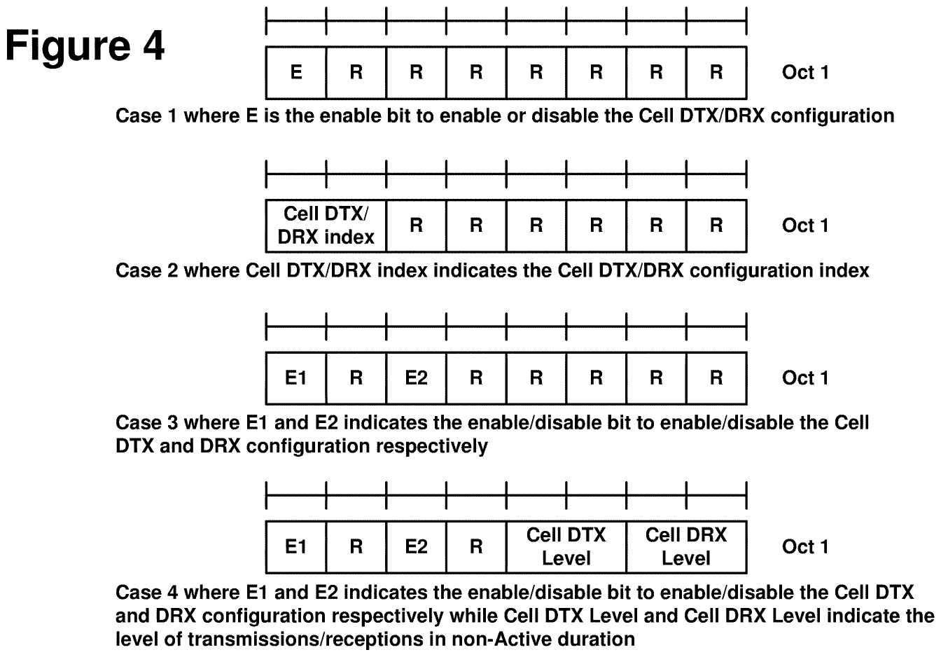

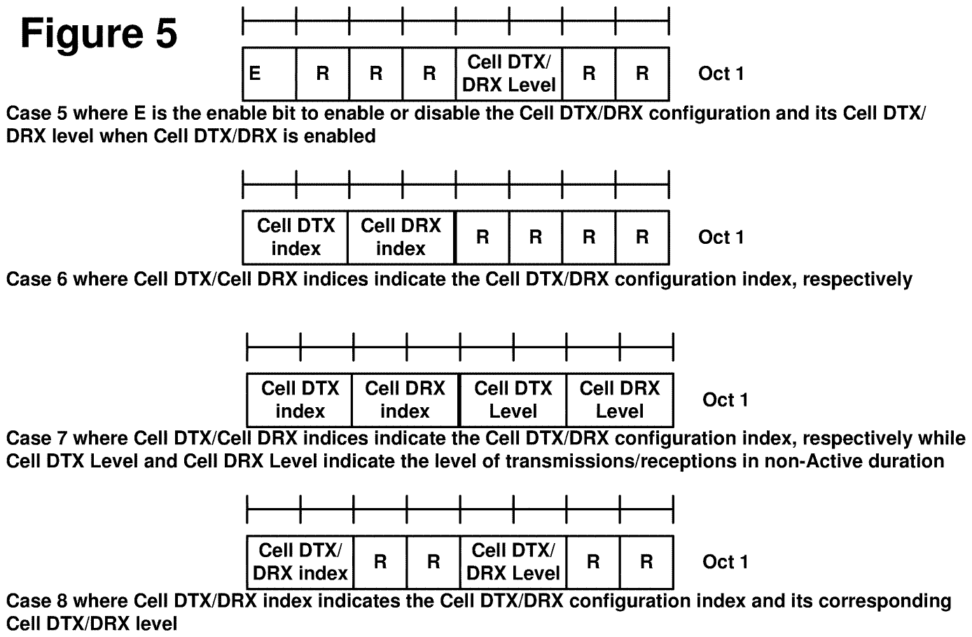

For using L2 signalling for the indication, the above L1/L2 contents are in a new MAC CE for UE specific case. In the case where Cell DTX/DRX is separately operated, the network should be able to enable/disable only Cell DRX, only Cell DTX or both Cell DRX and Cell DTX. The new variable length MAC CE format is illustrated in FIGS. 4 and 5 for the different cases as above with a new LCID in the subheader. Other variations of the MAC CE including variable length MAC CE format to accommodate to larger Cell DTX/DRX configuration indices or level indices are also covered by the embodiment.

Another embodiment is that there may be some occasions where the gNB wants to extend the Active duration for the UE in the cell due to some further downlink/uplink traffic. One simple approach is to introduce an inactivity timer triggered by the dedicated or common L1/L2 signalling. Whenever the network (cell) wants to extend the on-duration of the Cell DTX/DRX for the cell, it can send an indication in the common L1/L2 signalling to extend the active duration for the duration of the inactivity timer, in effect shorten the non-active duration of a Cell DTX/DRX cycle. The network can use the indication to indicate for how many Cell DTX/DRX cycles the inactivity timer should be performed. It can also just use the dedicated L1/L2 signalling to extend the Active duration for one or multiple cycles for a UE. Also, the extension of the active duration can be done separately for Cell DTX and Cell DRX.

Another approach is to use the same common L1/L2 signalling for enabling/disabling the Cell DTX/DRX to indicate to the UE to disable the Cell DTX/DRX in the cell. In the case when Cell DTX/DRX configured overrides the UE DRX, the UE will transmit and receive all the time. In the case when only enabled Cell DTX/DRX overrides the UE DRX, the UE will follow the UE DRX and the active duration can be extended based on the UE specific DRX. And when the extension of the active duration is no longer needed, the network can turn back on the Cell DTX/DRX via enabling the Cell DTX/DRX through the common L1/L2 signalling. It can also just use the dedicated L1/L2 signalling for just disabling/enabling the Cell DTX/DRX of a UE.

An alternative may be to introduce an inactivity timer similar to UE DRX (or in the case Cell DTX and DRX is separately configured, common or separate inactivity timer can be configured). For jointly configured Cell DTX and DRX, the inactivity timer is started whenever new DL assignment or UL grant is received by UE over PDCCH. For separately configured Cell DTX and DRX, the inactivity timer for the DL is started whenever new DL assignment in a PDCCH is received while for the UL, the inactivity timer is started whenever new UL grant in a PDCCH is received. For this alternative, the extension of the active period will depend on the traffic pattern of the UE and the extension of the active duration will vary from UE to UE.

### Systems and Implementations

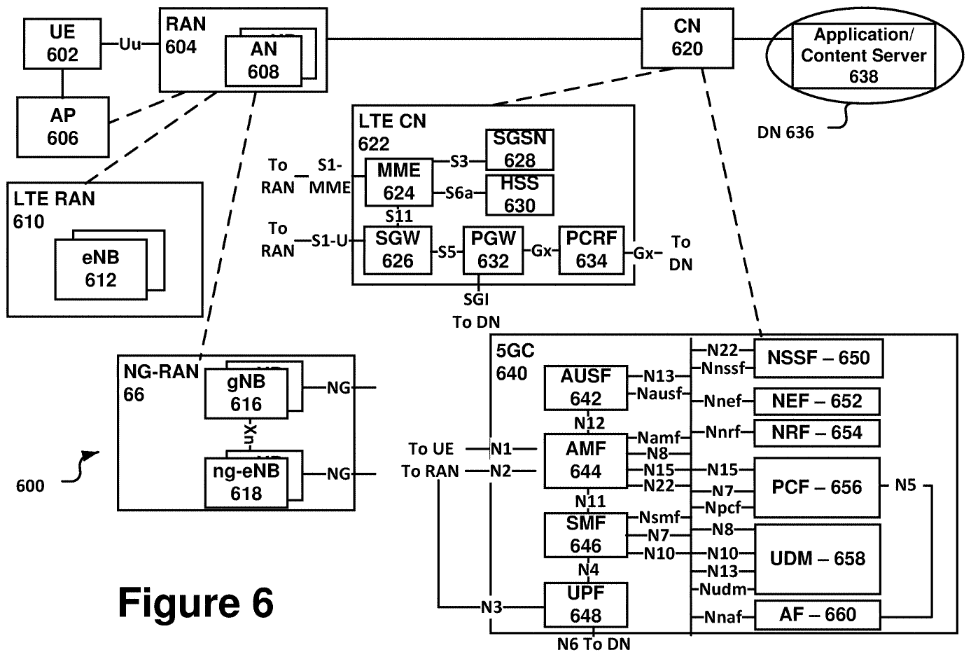

FIGS. 6-9 illustrate various systems, devices, and components that may implement aspects of disclosed embodiments.

FIG. 6 illustrates a network 600 in accordance with various embodiments. The network 600 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 600 may include a UE 602, which may include any mobile or non-mobile computing device designed to communicate with a RAN 604 via an over-the-air connection. The UE 602 may be communicatively coupled with the RAN 604 by a Uu interface. The UE 602 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 600 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 602 may additionally communicate with an AP 606 via an over-the-air connection. The AP 606 may manage a WLAN connection, which may serve to offload some/all network traffic from the RAN 604. The connection between the UE 602 and the AP 606 may be consistent with any IEEE 802.11 protocol, wherein the AP 606 could be a wireless fidelity (Wi-Fi®) router. In some embodiments, the UE 602, RAN 604, and AP 606 may utilize cellular-WLAN aggregation (for example, LWA/LWIP). Cellular-WLAN aggregation may involve the UE 602 being configured by the RAN 604 to utilize both cellular radio resources and WLAN resources.

The RAN 604 may include one or more access nodes, for example, AN 608. AN 608 may terminate air-interface protocols for the UE 602 by providing access stratum protocols including RRC, PDCP, RLC, MAC, and L1 protocols. In this manner, the AN 608 may enable data/voice connectivity between CN 620 and the UE 602. In some embodiments, the AN 608 may be implemented in a discrete device or as one or more software entities running on server computers as part of, for example, a virtual network, which may be referred to as a CRAN or virtual baseband unit pool. The AN 608 be referred to as a BS, gNB, RAN node, eNB, ng-eNB, NodeB, RSU, TRxP, TRP, etc. The AN 608 may be a macrocell base station or a low power base station for providing femtocells, picocells or other like cells having smaller coverage areas, smaller user capacity, or higher bandwidth compared to macrocells.

In embodiments in which the RAN 604 includes a plurality of ANs, they may be coupled with one another via an X2 interface (if the RAN 604 is an LTE RAN) or an Xn interface (if the RAN 604 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 604 may each manage one or more cells, cell groups, component carriers, etc. to provide the UE 602 with an air interface for network access. The UE 602 may be simultaneously connected with a plurality of cells provided by the same or different ANs of the RAN 604. For example, the UE 602 and RAN 604 may use carrier aggregation to allow the UE 602 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 604 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 602 or AN 608 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 604 may be an LTE RAN 610 with eNBs, for example, eNB 612. The LTE RAN 610 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 604 may be an NG-RAN 614 with gNBs, for example, gNB 616, or ng-eNBs, for example, ng-eNB 618. The gNB 616 may connect with 5G-enabled UEs using a 5G NR interface. The gNB 616 may connect with a 5G core through an NG interface, which may include an N2 interface or an N3 interface. The ng-eNB 618 may also connect with the 5G core through an NG interface, but may connect with a UE via an LTE air interface. The gNB 616 and the ng-eNB 618 may connect with each other over an Xn interface.

In some embodiments, the NG interface may be split into two parts, an NG user plane (NG-U) interface, which carries traffic data between the nodes of the NG-RAN 614 and a UPF 648 (e.g., N3 interface), and an NG control plane (NG-C) interface, which is a signaling interface between the nodes of the NG-RAN 614 and an AMF 644 (e.g., N2 interface).

The NG-RAN 614 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 602 can be configured with multiple BWPs where each BWP configuration has a different SCS. When a BWP change is indicated to the UE 602, the SCS of the transmission is changed as well. Another use case example of BWP is related to power saving. In particular, multiple BWPs can be configured for the UE 602 with different amount of frequency resources (for example, PRBs) to support data transmission under different traffic loading scenarios. A BWP containing a smaller number of PRBs can be used for data transmission with small traffic load while allowing power saving at the UE 602 and in some cases at the gNB 616. A BWP containing a larger number of PRBs can be used for scenarios with higher traffic load.

The RAN 604 is communicatively coupled to CN 620 that includes network elements to provide various functions to support data and telecommunications services to customers/subscribers (for example, users of UE 602). The components of the CN 620 may be implemented in one physical node or separate physical nodes. In some embodiments, NFV may be utilized to virtualize any or all of the functions provided by the network elements of the CN 620 onto physical compute/storage resources in servers, switches, etc. A logical instantiation of the CN 620 may be referred to as a network slice, and a logical instantiation of a portion of the CN 620 may be referred to as a network sub-slice.

In some embodiments, the CN 620 may be an LTE CN 622, which may also be referred to as an EPC. The LTE CN 622 may include MME 624, SGW 626, SGSN 628, HSS 630, PGW 632, and PCRF 634 coupled with one another over interfaces (or “reference points”) as shown. Functions of the elements of the LTE CN 622 may be briefly introduced as follows.

The MME 624 may implement mobility management functions to track a current location of the UE 602 to facilitate paging, bearer activation/deactivation, handovers, gateway selection, authentication, etc.

The SGW 626 may terminate an S1 interface toward the RAN and route data packets between the RAN and the LTE CN 622. The SGW 626 may be a local mobility anchor point for inter-RAN node handovers and also may provide an anchor for inter-3GPP mobility. Other responsibilities may include lawful intercept, charging, and some policy enforcement.

The SGSN 628 may track a location of the UE 602 and perform security functions and access control. In addition, the SGSN 628 may perform inter-EPC node signaling for mobility between different RAT networks; PDN and S-GW selection as specified by MME 624; MME selection for handovers; etc. The S3 reference point between the MME 624 and the SGSN 628 may enable user and bearer information exchange for inter-3GPP access network mobility in idle/active states.

The HSS 630 may include a database for network users, including subscription-related information to support the network entities' handling of communication sessions. The HSS 630 can provide support for routing/roaming, authentication, authorization, naming/addressing resolution, location dependencies, etc. An S6a reference point between the HSS 630 and the MME 624 may enable transfer of subscription and authentication data for authenticating/authorizing user access to the LTE CN 620.

The PGW 632 may terminate an SGi interface toward a data network (DN) 636 that may include an application/content server 638. The PGW 632 may route data packets between the LTE CN 622 and the data network 636. The PGW 632 may be coupled with the SGW 626 by an S5 reference point to facilitate user plane tunneling and tunnel management. The PGW 632 may further include a node for policy enforcement and charging data collection (for example, PCEF). Additionally, the SGi reference point between the PGW 632 and the data network 636 may be an operator external public, a private PDN, or an intra-operator packet data network, for example, for provision of IMS services. The PGW 632 may be coupled with a PCRF 634 via a Gx reference point.

The PCRF 634 is the policy and charging control element of the LTE CN 622. The PCRF 634 may be communicatively coupled to the app/content server 638 to determine appropriate QoS and charging parameters for service flows. The PCRF 632 may provision associated rules into a PCEF (via Gx reference point) with appropriate TFT and QCI.

In some embodiments, the CN 620 may be a 5GC 640. The 5GC 640 may include an AUSF 642, AMF 644, SMF 646, UPF 648, NSSF 650, NEF 652, NRF 654, PCF 656, UDM 658, and AF 660 coupled with one another over interfaces (or “reference points”) as shown. Functions of the elements of the 5GC 640 may be briefly introduced as follows.

The AUSF 642 may store data for authentication of UE 602 and handle authentication-related functionality. The AUSF 642 may facilitate a common authentication framework for various access types. In addition to communicating with other elements of the 5GC 640 over reference points as shown, the AUSF 642 may exhibit an Nausf service-based interface.

The AMF 644 may allow other functions of the 5GC 640 to communicate with the UE 602 and the RAN 604 and to subscribe to notifications about mobility events with respect to the UE 602. The AMF 644 may be responsible for registration management (for example, for registering UE 602), connection management, reachability management, mobility management, lawful interception of AMF-related events, and access authentication and authorization. The AMF 644 may provide transport for SM messages between the UE 602 and the SMF 646, and act as a transparent proxy for routing SM messages. AMF 644 may also provide transport for SMS messages between UE 602 and an SMSF. AMF 644 may interact with the AUSF 642 and the UE 602 to perform various security anchor and context management functions. Furthermore, AMF 644 may be a termination point of a RAN CP interface, which may include or be an N2 reference point between the RAN 604 and the AMF 644; and the AMF 644 may be a termination point of NAS (N1) signaling, and perform NAS ciphering and integrity protection. AMF 644 may also support NAS signaling with the UE 602 over an N3 IWF interface.

The SMF 646 may be responsible for SM (for example, session establishment, tunnel management between UPF 648 and AN 608); UE IP address allocation and management (including optional authorization); selection and control of UP function; configuring traffic steering at UPF 648 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 644 over N2 to AN 608; and determining SSC mode of a session. SM may refer to management of a PDU session, and a PDU session or “session” may refer to a PDU connectivity service that provides or enables the exchange of PDUs between the UE 602 and the data network 636.

The UPF 648 may act as an anchor point for intra-RAT and inter-RAT mobility, an external PDU session point of interconnect to data network 636, and a branching point to support multi-homed PDU session. The UPF 648 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 648 may include an uplink classifier to support routing traffic flows to a data network.

The NSSF 650 may select a set of network slice instances serving the UE 602. The NSSF 650 may also determine allowed NSSAI and the mapping to the subscribed S-NSSAIs, if needed. The NSSF 650 may also determine the AMF set to be used to serve the UE 602, or a list of candidate AMFs based on a suitable configuration and possibly by querying the NRF 654. The selection of a set of network slice instances for the UE 602 may be triggered by the AMF 644 with which the UE 602 is registered by interacting with the NSSF 650, which may lead to a change of AMF. The NSSF 650 may interact with the AMF 644 via an N22 reference point; and may communicate with another NSSF in a visited network via an N31 reference point (not shown). Additionally, the NSSF 650 may exhibit an Nnssf service-based interface.

The NEF 652 may securely expose services and capabilities provided by 3GPP network functions for third party, internal exposure/re-exposure, AFs (e.g., AF 660), edge computing or fog computing systems, etc. In such embodiments, the NEF 652 may authenticate, authorize, or throttle the AFs. NEF 652 may also translate information exchanged with the AF 660 and information exchanged with internal network functions. For example, the NEF 652 may translate between an AF-Service-Identifier and an internal 5GC information. NEF 652 may also receive information from other NFs based on exposed capabilities of other NFs. This information may be stored at the NEF 652 as structured data, or at a data storage NF using standardized interfaces. The stored information can then be re-exposed by the NEF 652 to other NFs and AFs, or used for other purposes such as analytics. Additionally, the NEF 652 may exhibit an Nnef service-based interface.

The NRF 654 may support service discovery functions, receive NF discovery requests from NF instances, and provide the information of the discovered NF instances to the NF instances. NRF 654 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 654 may exhibit the Nnrf service-based interface.

The PCF 656 may provide policy rules to control plane functions to enforce them, and may also support unified policy framework to govern network behavior. The PCF 656 may also implement a front end to access subscription information relevant for policy decisions in a UDR of the UDM 658. In addition to communicating with functions over reference points as shown, the PCF 656 exhibit an Npcf service-based interface.

The UDM 658 may handle subscription-related information to support the network entities' handling of communication sessions, and may store subscription data of UE 602. For example, subscription data may be communicated via an N8 reference point between the UDM 658 and the AMF 644. The UDM 658 may include two parts, an application front end and a UDR. The UDR may store subscription data and policy data for the UDM 658 and the PCF 656, and/or structured data for exposure and application data (including PFDs for application detection, application request information for multiple UEs 602) for the NEF 652. The Nudr service-based interface may be exhibited by the UDR 221 to allow the UDM 658, PCF 656, and NEF 652 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 658 may exhibit the Nudm service-based interface.

The AF 660 may provide application influence on traffic routing, provide access to NEF, and interact with the policy framework for policy control.

In some embodiments, the 5GC 640 may enable edge computing by selecting operator/3^{rd} party services to be geographically close to a point that the UE 602 is attached to the network. This may reduce latency and load on the network. To provide edge-computing implementations, the 5GC 640 may select a UPF 648 close to the UE 602 and execute traffic steering from the UPF 648 to data network 636 via the N6 interface. This may be based on the UE subscription data, UE location, and information provided by the AF 660. In this way, the AF 660 may influence UPF (re) selection and traffic routing. Based on operator deployment, when AF 660 is considered to be a trusted entity, the network operator may permit AF 660 to interact directly with relevant NFs. Additionally, the AF 660 may exhibit an Naf service-based interface.

The data network 636 may represent various network operator services, Internet access, or third party services that may be provided by one or more servers including, for example, application/content server 638.

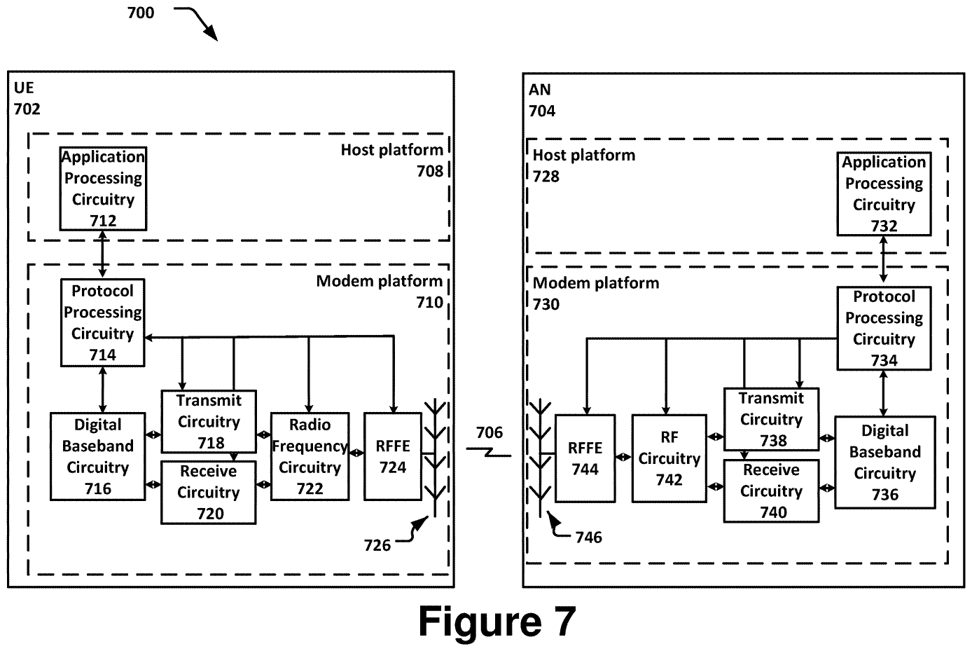

FIG. 7 schematically illustrates a wireless network 700 in accordance with various embodiments. The wireless network 700 may include a UE 702 in wireless communication with an AN 704. The UE 702 and AN 704 may be similar to, and substantially interchangeable with, like-named components described elsewhere herein.

The UE 702 may be communicatively coupled with the AN 704 via connection 706. The connection 706 is illustrated as an air interface to enable communicative coupling, and can be consistent with cellular communications protocols such as an LTE protocol or a 5G NR protocol operating at mmWave or sub-6 GHZ frequencies.

The UE 702 may include a host platform 708 coupled with a modem platform 710. The host platform 708 may include application processing circuitry 712, which may be coupled with protocol processing circuitry 714 of the modem platform 710. The application processing circuitry 712 may run various applications for the UE 702 that source/sink application data. The application processing circuitry 712 may further implement one or more layer operations to transmit/receive application data to/from a data network. These layer operations may include transport (for example UDP) and Internet (for example, IP) operations

The protocol processing circuitry 714 may implement one or more of layer operations to facilitate transmission or reception of data over the connection 706. The layer operations implemented by the protocol processing circuitry 714 may include, for example, MAC, RLC, PDCP, RRC and NAS operations.

The modem platform 710 may further include digital baseband circuitry 716 that may implement one or more layer operations that are “below” layer operations performed by the protocol processing circuitry 714 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 710 may further include transmit circuitry 718, receive circuitry 720, RF circuitry 722, and RF front end (RFFE) 724, which may include or connect to one or more antenna panels 726. Briefly, the transmit circuitry 718 may include a digital-to-analog converter, mixer, intermediate frequency (IF) components, etc.; the receive circuitry 720 may include an analog-to-digital converter, mixer, IF components, etc.; the RF circuitry 722 may include a low-noise amplifier, a power amplifier, power tracking components, etc.; RFFE 724 may include filters (for example, surface/bulk acoustic wave filters), switches, antenna tuners, beamforming components (for example, phase-array antenna components), etc. The selection and arrangement of the components of the transmit circuitry 718, receive circuitry 720, RF circuitry 722, RFFE 724, and antenna panels 726 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 714 may include one or more instances of control circuitry (not shown) to provide control functions for the transmit/receive components.

A UE reception may be established by and via the antenna panels 726, RFFE 724, RF circuitry 722, receive circuitry 720, digital baseband circuitry 716, and protocol processing circuitry 714. In some embodiments, the antenna panels 726 may receive a transmission from the AN 704 by receive-beamforming signals received by a plurality of antennas/antenna elements of the one or more antenna panels 726.

A UE transmission may be established by and via the protocol processing circuitry 714, digital baseband circuitry 716, transmit circuitry 718, RF circuitry 722, RFFE 724, and antenna panels 726. In some embodiments, the transmit components of the UE 704 may apply a spatial filter to the data to be transmitted to form a transmit beam emitted by the antenna elements of the antenna panels 726.

Similar to the UE 702, the AN 704 may include a host platform 728 coupled with a modem platform 730. The host platform 728 may include application processing circuitry 732 coupled with protocol processing circuitry 734 of the modem platform 730. The modem platform may further include digital baseband circuitry 736, transmit circuitry 738, receive circuitry 740, RF circuitry 742, RFFE circuitry 744, and antenna panels 746. The components of the AN 704 may be similar to and substantially interchangeable with like-named components of the UE 702. In addition to performing data transmission/reception as described above, the components of the AN 708 may perform various logical functions that include, for example, RNC functions such as radio bearer management, uplink and downlink dynamic radio resource management, and data packet scheduling.

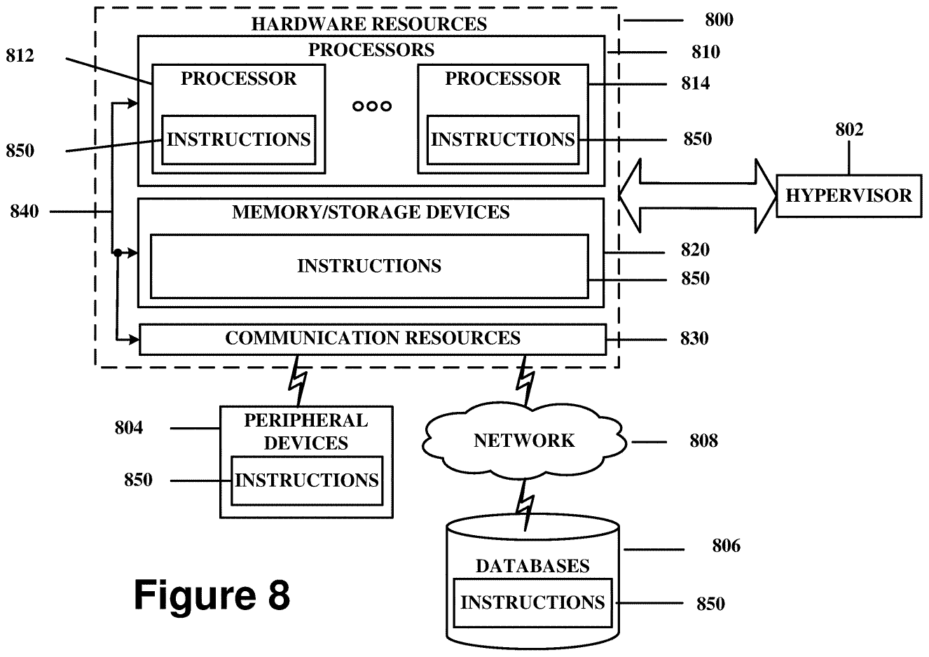

FIG. 8 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors (or processor cores) 810, one or more memory/storage devices 820, and one or more communication resources 830, each of which may be communicatively coupled via a bus 840 or other interface circuitry. For embodiments where node virtualization (e.g., NFV) is utilized, a hypervisor 802 may be executed to provide an execution environment for one or more network slices/sub-slices to utilize the hardware resources 800.

The processors 810 may include, for example, a processor 812 and a processor 814. The processors 810 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 820 may include main memory, disk storage, or any suitable combination thereof. The memory/storage devices 820 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 830 may include interconnection or network interface controllers, components, or other suitable devices to communicate with one or more peripheral devices 804 or one or more databases 806 or other network elements via a network 808. For example, the communication resources 830 may include wired communication components (e.g., for coupling via USB, Ethernet, etc.), cellular communication components, NFC components, Bluetooth® (or Bluetooth® Low Energy) components, Wi-Fi® components, and other communication components.

Instructions 850 may comprise software, a program, an application, an applet, an app, or other executable code for causing at least any of the processors 810 to perform any one or more of the methodologies discussed herein. The instructions 850 may reside, completely or partially, within at least one of the processors 810 (e.g., within the processor's cache memory), the memory/storage devices 820, or any suitable combination thereof. Furthermore, any portion of the instructions 850 may be transferred to the hardware resources 800 from any combination of the peripheral devices 804 or the databases 806. Accordingly, the memory of processors 810, the memory/storage devices 820, the peripheral devices 804, and the databases 806 are examples of computer-readable and machine-readable media.

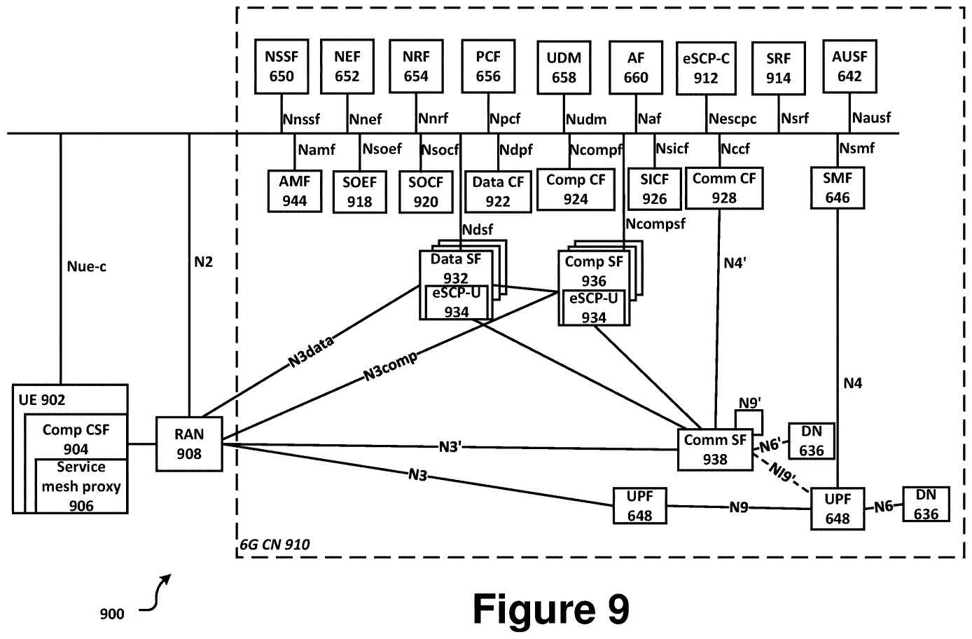

FIG. 9 illustrates a network 900 in accordance with various embodiments. The network 900 may operate in a matter consistent with 3GPP technical specifications or technical reports for 6G systems. In some embodiments, the network 900 may operate concurrently with network 600. For example, in some embodiments, the network 900 may share one or more frequency or bandwidth resources with network 600. As one specific example, a UE (e.g., UE 902) may be configured to operate in both network 900 and network 600. Such configuration may be based on a UE including circuitry configured for communication with frequency and bandwidth resources of both networks 600 and 900. In general, several elements of network 900 may share one or more characteristics with elements of network 600. For the sake of brevity and clarity, such elements may not be repeated in the description of network 900.

The network 900 may include a UE 902, which may include any mobile or non-mobile computing device designed to communicate with a RAN 908 via an over-the-air connection. The UE 902 may be similar to, for example, UE 602. The UE 902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 9, in some embodiments the network 900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 9, the UE 902 may be communicatively coupled with an AP such as AP 606 as described with respect to FIG. 6. Additionally, although not specifically shown in FIG. 9, in some embodiments the RAN 908 may include one or more ANss such as AN 608 as described with respect to FIG. 6. The RAN 908 and/or the AN of the RAN 908 may be referred to as a base station (BS), a RAN node, or using some other term or name.

The UE 902 and the RAN 908 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 908 may allow for communication between the UE 902 and a 6G core network (CN) 910. Specifically, the RAN 908 may facilitate the transmission and reception of data between the UE 902 and the 6G CN 910. The 6G CN 910 may include various functions such as NSSF 650, NEF 652, NRF 654, PCF 656, UDM 658, AF 660, SMF 646, and AUSF 642. The 6G CN 910 may additional include UPF 648 and DN 636 as shown in FIG. 9.

Additionally, the RAN 908 may include various additional functions that are in addition to, or alternative to, functions of a legacy cellular network such as a 4G or 5G network. Two such functions may include a Compute Control Function (Comp CF) 924 and a Compute Service Function (Comp SF) 936. The Comp CF 924 and the Comp SF 936 may be parts or functions of the Computing Service Plane. Comp CF 924 may be a control plane function that provides functionalities such as management of the Comp SF 936, computing task context generation and management (e.g., create, read, modify, delete), interaction with the underlaying computing infrastructure for computing resource management, etc., Comp SF 936 may be a user plane function that serves as the gateway to interface computing service users (such as UE 902) and computing nodes behind a Comp SF instance. Some functionalities of the Comp SF 936 may include: parse computing service data received from users to compute tasks executable by computing nodes; hold service mesh ingress gateway or service API gateway; service and charging policies enforcement; performance monitoring and telemetry collection, etc. In some embodiments, a Comp SF 936 instance may serve as the user plane gateway for a cluster of computing nodes. A Comp CF 924 instance may control one or more Comp SF 936 instances.

Two other such functions may include a Communication Control Function (Comm CF) 928 and a Communication Service Function (Comm SF) 938, which may be parts of the Communication Service Plane. The Comm CF 928 may be the control plane function for managing the Comm SF 938, communication sessions creation/configuration/releasing, and managing communication session context. The Comm SF 938 may be a user plane function for data transport. Comm CF 928 and Comm SF 938 may be considered as upgrades of SMF 646 and UPF 648, which were described with respect to a 5G system in FIG. 6. The upgrades provided by the Comm CF 928 and the Comm SF 938 may enable service-aware transport. For legacy (e.g., 4G or 5G) data transport, SMF 646 and UPF 648 may still be used.

Two other such functions may include a Data Control Function (Data CF) 922 and Data Service Function (Data SF) 932 may be parts of the Data Service Plane. Data CF 922 may be a control plane function and provides functionalities such as Data SF 932 management, Data service creation/configuration/releasing, Data service context management, etc. Data SF 932 may be a user plane function and serve as the gateway between data service users (such as UE 902 and the various functions of the 6G CN 910) and data service endpoints behind the gateway. Specific functionalities may include: parse data service user data and forward to corresponding data service endpoints, generate charging data, report data service status.

Another such function may be the Service Orchestration and Chaining Function (SOCF) 920, which may discover, orchestrate and chain up communication/computing/data services provided by functions in the network. Upon receiving service requests from users, SOCF 920 may interact with one or more of Comp CF 924, Comm CF 928, and Data CF 922 to identify Comp SF 936, Comm SF 938, and Data SF 932 instances, configure service resources, and generate the service chain, which could contain multiple Comp SF 936, Comm SF 938, and Data SF 932 instances and their associated computing endpoints. Workload processing and data movement may then be conducted within the generated service chain. The SOCF 920 may also responsible for maintaining, updating, and releasing a created service chain.

Another such function may be the service registration function (SRF) 914, which may act as a registry for system services provided in the user plane such as services provided by service endpoints behind Comp SF 936 and Data SF 932 gateways and services provided by the UE 902. The SRF 914 may be considered a counterpart of NRF 654, which may act as the registry for network functions.

Other such functions may include an evolved service communication proxy (eSCP) and service infrastructure control function (SICF) 926, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 912 and eSCP-U 934, for control plane service communication proxy and user plane service communication proxy, respectively. The SICF 926 may control and configure eCSP instances in terms of service traffic routing policies, access rules, load balancing configurations, performance monitoring, etc.

Another such function is the AMF 944. The AMF 944 may be similar to 644, but with additional functionality. Specifically, the AMF 944 may include potential functional repartition, such as move the message forwarding functionality from the AMF 944 to the RAN 908.

Another such function is the service orchestration exposure function (SOEF) 918. The SOEF may be configured to expose service orchestration and chaining services to external users such as applications.

The UE 902 may include an additional function that is referred to as a computing client service function (comp CSF) 904. The comp CSF 904 may have both the control plane functionalities and user plane functionalities, and may interact with corresponding network side functions such as SOCF 920, Comp CF 924, Comp SF 936, Data CF 922, and/or Data SF 932 for service discovery, request/response, compute task workload exchange, etc. The Comp CSF 904 may also work with network side functions to decide on whether a computing task should be run on the UE 902, the RAN 908, and/or an element of the 6G CN 910.

The UE 902 and/or the Comp CSF 904 may include a service mesh proxy 906. The service mesh proxy 906 may act as a proxy for service-to-service communication in the user plane. Capabilities of the service mesh proxy 906 may include one or more of addressing, security, load balancing, etc.

### Example Procedures

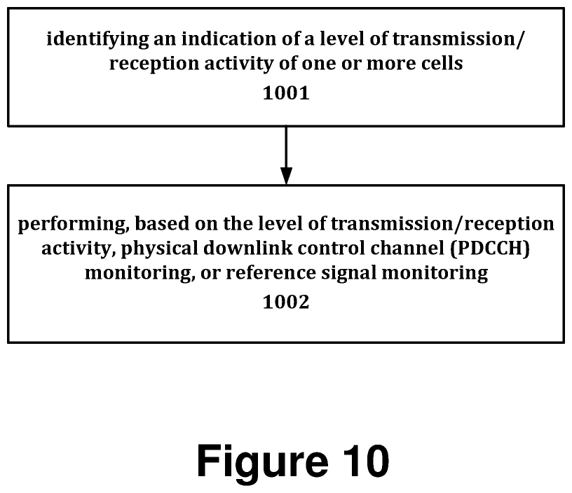

In some embodiments, the electronic device(s), network(s), system(s), chip(s) or component(s), or portions or implementations thereof, of FIGS. 6-9, or some other figure herein, may be configured to perform one or more processes, techniques, or methods as described herein, or portions thereof. One such process is depicted in FIG. 10. The process of FIG. 10 may include or relate to a method to be performed by a user equipment (UE), one or more elements of a UE, and/or an electronic device that includes or implements a UE. The process may include identifying, at 1001, an indication of a level of transmission/reception activity of one or more cells; and performing, at 1002 based on the level of transmission/reception activity, physical downlink control channel (PDCCH) monitoring, or reference signal monitoring.

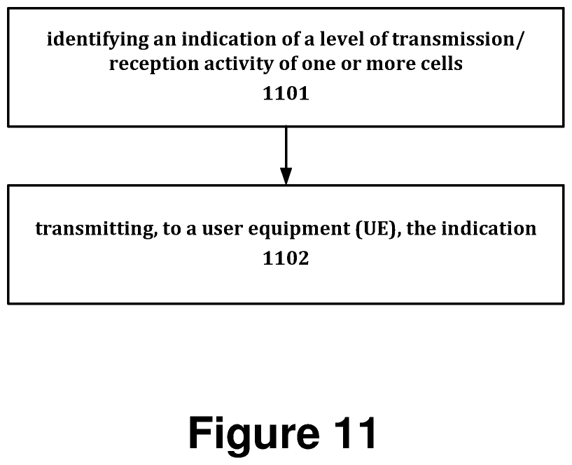

Another such process is depicted in FIG. 11. The process of FIG. 11 may include or relate to a method to be performed by an electronic device of a cellular network. The process may include identifying, at 1101, an indication of a level of transmission/reception activity of one or more cells; and transmitting, at 1102 to a user equipment (UE), the indication.

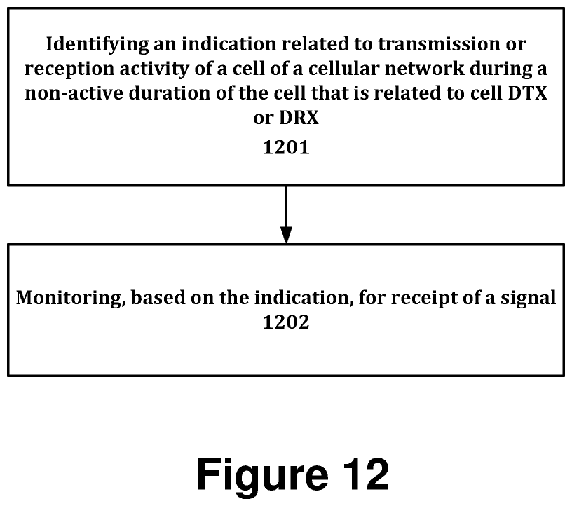

Another such process is depicted in FIG. 12. The process of FIG. 12 may include or relate to a method to be performed by a user equipment (UE), one or more elements of a UE, and/or an electronic device that includes and/or implements a UE. The process may include identifying, at 1201 by the UE, an indication related to transmission or reception activity of a cell of a cellular network during a non-active duration of the cell that is related to cell discontinuous transmission (DTX) or cell discontinuous reception (DRX); and monitoring, at 1202 by the UE based on the indication, for receipt of a signal.

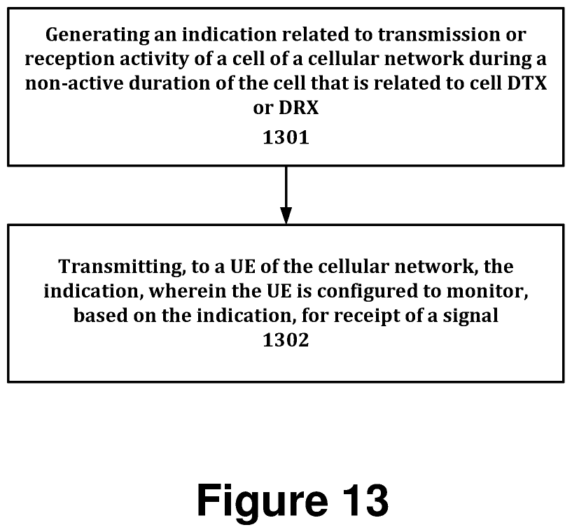

Another such process is depicted in FIG. 13. The process of FIG. 13 may include or relate to a method to be performed by a base station, one or more elements of a base station, and/or an electronic device that includes and/or implements a base station. The process may include generating, at 1301 by the base station, an indication related to transmission or reception activity of a cell of a cellular network during a non-active duration of the cell that is related to cell discontinuous transmission (DTX) or cell discontinuous reception (DRX); and transmitting, at 1302 to a user equipment (UE) of the cellular network, the indication, wherein the UE is configured to monitor, based on the indication, for receipt of a signal.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include the method of 5G NR UE, where receiving by the UE, an indication on the level of transmissions and receptions in the non-Active duration for a cell or a group of cells (in the CA case where the Cell DTX/DRX configuration is the same) where, the level indicates the transmission/reception activity during the non-Active duration for a UE and dictates the UE operation corresponding to PDCCH monitoring, reception of reference signals and other dedicated and common signals.

Example 2 may include the method of example 1 or some other example herein, where the different levels of transmissions and receptions in the non-Active duration are configured when the Cell DRX/DTX are configured via RRC configuration as part of the Cell DTX/DRX configuration or separately.

Example 3 may include the method of example 1 or some other example herein, where the indication on the level of transmissions and receptions in the non-Active duration for Cell DTX and Cell DRX is sent via RRC signalling or via L1/L2 signalling.

Example 4 may include the method of example 1 or some other example herein, where the level of transmissions and receptions in the non-Active duration is determined based on the QOS requirements and RRM and scheduling measurement requirements of the UEs or group of UEs or a single UE in the cell.

Example 5 may include the method of example 1 or some other example herein, where the Cell DRX/DTX operation overrides the UE DRX operation if both are configured and Cell DRX/DTX operation is activated/enabled.

Example 6 may include the method of example 1 or some other example herein, where the Active duration of Cell DRX/DTX can be extended via L1/L2 signalling.

Example 7 includes a method to be performed by a user equipment (UE), one or more elements of a UE, and/or an electronic device that includes or implements a UE, wherein the method comprises:

identifying an indication of a level of transmission/reception activity of one or more cells; and

performing, based on the level of transmission/reception activity, physical downlink control channel (PDCCH) monitoring, or reference signal monitoring.

Example 8 includes the method of example 7 and/or some other example herein, wherein the one or more cells are a cell group in carrier aggregation (CA).

Example 9 includes the method of any of examples 7-8, and/or some other example herein, wherein the transmission/reception activity relates to cell discontinuous transmission (DTX)/discontinuous reception (DRX).

Example 10 includes the method of example 9, and/or some other example herein, wherein the level of transmission/reception activity is related to a non-active duration of the DTX/DRX.

Example 11 includes the method of example 9, and/or some other example herein, wherein the indication is based on radio resource control (RRC) configuration related to the cell DTX/DRX operation.

Example 12 includes the method of example 11, and/or some other example herein, wherein the RRC configuration is transmitted via layer 1/layer 2 (L1/L2) signaling.

Example 13 includes a method to be performed by an electronic device of a cellular network, wherein the method comprises:
identifying an indication of a level of transmission/reception activity of one or more cells; and
transmitting, to a user equipment (UE), the indication.

Example 14 includes the method of example 13 and/or some other example herein, wherein the one or more cells are a cell group in carrier aggregation (CA).

Example 15 includes the method of any of examples 13-14, and/or some other example herein, wherein the transmission/reception activity relates to cell discontinuous transmission (DTX)/discontinuous reception (DRX).

Example 16 includes the method of example 15, and/or some other example herein, wherein the level of transmission/reception activity is related to a non-active duration of the DTX/DRX.

Example 17 includes the method of example 15, and/or some other example herein, wherein the indication is transmitted in radio resource control (RRC) configuration related to the cell DTX/DRX operation.

Example 18 includes the method of example 17, and/or some other example herein, wherein the RRC configuration is transmitted via layer 1/layer 2 (L1/L2) signaling.

Example 19 includes a method to be performed by a user equipment (UE), one or more elements of a UE, and/or an electronic device that includes and/or implements a UE, wherein the method comprises: identifying, by the UE, an indication related to transmission or reception activity of a cell of a cellular network during a non-active duration of the cell that is related to cell discontinuous transmission (DTX) or cell discontinuous reception (DRX); and monitoring, by the UE based on the indication, for receipt of a signal.

Example 20 includes the method of example 19, and/or some other example herein, wherein the indication is received via higher-layer signaling.

Example 21 includes the method of example 20, and/or some other example herein, wherein the higher-layer signaling is radio resource control (RRC) signaling or layer 1/layer 2 (L1/L2) signaling.

Example 22 includes the method of any of examples 19-21, and/or some other example herein, wherein the indication relates to transmission or reception activity of a plurality of cells, and wherein the plurality of cells have a same configuration of cell DTX or cell DRX.

Example 23 includes the method of any of examples 19-22, and/or some other example herein, wherein the monitoring for receipt of the signal relates to physical downlink control channel (PDCCH) monitoring.

Example 24 includes the method of any of examples 19-23, and/or some other example herein, wherein monitoring for receipt of the signal relates to receipt of a reference signal.

Example 25 includes the method of any of examples 19-24, and/or some other example herein, wherein the UE is further configured to: identify, during the non-active duration, that the UE is configured with UE DRX operation during the non-active duration; act, during the non-active duration, in accordance with cell DTX or cell DRX; and not act, during the non-active duration, in accordance with the UE DRX operation.

Example 26 includes a method to be performed by a base station, one or more elements of a base station, and/or an electronic device that includes and/or implements a base station, wherein the method comprises: generating, by the base station, an indication related to transmission or reception activity of a cell of a cellular network during a non-active duration of the cell that is related to cell discontinuous transmission (DTX) or cell discontinuous reception (DRX); and transmitting, to a user equipment (UE) of a cellular network, the indication, wherein the UE is configured to monitor, based on the indication, for receipt of a signal.

Example 27 includes the method of example 26, and/or some other example herein, wherein the indication is transmitted via higher-layer signaling.

Example 28 includes the method of example 27, and/or some other example herein, wherein the higher-layer signaling is radio resource control (RRC) signaling or layer 1/layer 2 (L1/L2) signaling.

Example 29 includes the method of any of examples 26-28, and/or some other example herein, wherein the indication relates to transmission or reception activity of a plurality of cells, and wherein the plurality of cells have a same configuration of cell DTX or cell DRX.

Example 30 includes the method of any of examples 26-29, and/or some other example herein, wherein the monitoring for receipt of the signal relates to physical downlink control channel (PDCCH) monitoring.

Example 31 includes the method of any of examples 26-30, and/or some other example herein, wherein monitoring for receipt of the signal relates to receipt of a reference signal.

Example 32 includes the method of any of examples 26-31, and/or some other example herein, wherein the UE is further configured to: identify, during the non-active duration, that the UE is configured with UE DRX operation during the non-active duration; act, during the non-active duration, in accordance with cell DTX or cell DRX; and not act, during the non-active duration, in accordance with the UE DRX operation.

the Example Z01 may include an apparatus comprising means to perform one or more elements of a method described in or related to any of examples 1-18, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-18, or any other method or process described herein.

Example Z03 may include an apparatus comprising logic, modules, or circuitry to perform one or more elements of a method described in or related to any of examples 1-18, or any other method or process described herein.

Example Z04 may include a method, technique, or process as described in or related to any of examples 1-18, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-18, or portions thereof.

Example Z06 may include a signal as described in or related to any of examples 1-18, or portions or parts thereof.

Example Z07 may include a datagram, packet, frame, segment, protocol data unit (PDU), or message as described in or related to any of examples 1-18, or portions or parts thereof, or otherwise described in the present disclosure.

Example Z08 may include a signal encoded with data as described in or related to any of examples 1-18, or portions or parts thereof, or otherwise described in the present disclosure.

Example Z09 may include a signal encoded with a datagram, packet, frame, segment, protocol data unit (PDU), or message as described in or related to any of examples 1-18, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-18, or portions thereof.

Example Z11 may include a computer program comprising instructions, wherein execution of the program by a processing element is to cause the processing element to carry out the method, techniques, or process as described in or related to any of examples 1-18, or portions thereof.

Example Z12 may include a signal in a wireless network as shown and described herein. Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | | | | | |
|---|---|---|---|---|---|
| | 3GPP Third | 35 | AN Access | 70 | BER Bit Error Ratio |
| | Generation | | Network | | BFD Beam |
| | Partnership | | AnLF Analytics | | Failure Detection |
| | Project | | Logical Function | | BLER Block Error |
| 5 | 4G Fourth | | ANR Automatic | | Rate |
| | Generation | 40 | Neighbour Relation | 75 | BPSK Binary Phase |
| | 5G Fifth | | AOA Angle of | | Shift Keying |
| | Generation | | Arrival | | BRAS Broadband |
| | 5GC 5G Core | | AP Application | | Remote Access |
| 10 | network | | Protocol, Antenna | | Server |
| | AC | 45 | Port, Access Point | 80 | BSS Business |
| | Application | | API Application | | Support System |
| | Client | | Programming Interface | | BS Base Station |
| | ACR Application | | APN Access Point | | BSR Buffer Status |
| 15 | Context Relocation | | Name | | Report |
| | ACK | 50 | ARP Allocation and | 85 | BW Bandwidth |
| | Acknowledgement | | Retention Priority | | BWP Bandwidth Part |
| | ACID | | ARQ Automatic | | C-RNTI Cell |
| | | | Repeat Request | | Radio Network |
| 20 | Application | | AS Access Stratum | | Temporary |
| | Client Identification | 55 | ASP | 90 | Identity |
| | ADRF Analytics Data | | Application | | CA Carrier |
| | Repository | | Service | | Aggregation, |
| | Function | | Provider | | Certification |
| 25 | AF Application | 60 | ASN.1 Abstract Syntax | | Authority |
| | Function | | Notation One | 95 | CAPEX CAPital |
| | AM Acknowledged | | AUSF Authentication | | Expenditure |
| | Mode | | Server Function | | CBD Candidate |
| | AMBR Aggregate | | AWGN Additive | | Beam Detection |
| 30 | Maximum Bit Rate | | White Gaussian | | CBRA Contention |
| | AMF Access and | 65 | Noise | 100 | Based Random |
| | Mobility | | BAP Backhaul | | Access |
| | Management | | Adaptation Protocol | | CC Component |
| | Function | | BCH Broadcast | | Carrier, |
| | Code, Cryptographic | | Channel | | Country |
| | Checksum | 35 | CM Connection | 70 | C/R |
| | CCA Clear | | Management, | | Command/Resp |
| | Channel | | Conditional | | onse field bit |
| | Assessment | | Mandatory | | CRAN Cloud Radio |
| 5 | CCE Control | | CMAS Commercial | | Access |
| | Channel Element | 40 | Mobile Alert Service | | Network, Cloud |
| | CCCH Common | | CMD Command | | RAN |
| | Control Channel | | CMS Cloud | 75 | CRB Common |
| | CE Coverage | | Management System | | Resource Block |
| 10 | Enhancement | | CO Conditional | | CRC Cyclic |
| | CDM Content | 45 | Optional | | Redundancy Check |
| | Delivery Network | | COMP Coordinated | | CRI Channel-State |
| | CDMA Code- | | Multi-Point | 80 | Information |
| | Division Multiple | | CORESET Control | | Resource |
| 15 | Access | | Resource Set | | Indicator, CSI-RS |
| | CDR Charging Data | 50 | COTS Commercial | | Resource |
| | Request | | Off-The-Shelf | | Indicator |
| | CDR Charging Data | | CP Control Plane, | 85 | C-RNTI Cell |
| | Response | | Cyclic Prefix, | | RNTI |
| 20 | CFRA Contention Free | | Connection | | CS Circuit |
| | Random Access | 55 | Point | | Switched |
| | CG Cell Group | | CPD Connection | 90 | CSCF call |
| | CGF Charging | | Point Descriptor | | session control function |
| | Gateway Function | | CPE Customer | | CSAR Cloud Service |
| 25 | CHF Charging | | Premise | | Archive |
| | Function | 60 | Equipment | | CSI Channel-State |
| | CI Cell Identity | | CPICH Common Pilot | | Information |
| | CID Cell-ID (e.g., | | Channel | 95 | CSI-IM CSI |
| | positioning method) | | CQI Channel | | Interference |
| 30 | CIM Common | | Quality Indicator | | Measurement |
| | Information Model | 65 | CPU CSI processing | | CSI-RS CSI |
| | CIR Carrier to | | unit, Central | | Reference Signal |
| | Interference Ratio | | Processing | 100 | CSI-RSRP CSI |
| | CK Cipher Key | | Unit | | reference signal |
| | CSI-RSRQ CSI | | DMTF Distributed | | ECCA extended clear |
| | reference signal | 35 | Management Task | | channel |
| | received quality | | Force | 70 | assessment, |
| | CSI-SINR CSI | | DPDK Data Plane | | extended CCA |
| 5 | signal-to-noise and | | Development Kit | | ECCE Enhanced |
| | interference | | DM-RS, DMRS | | Control Channel |
| | ratio | 40 | Demodulation | | Element, |
| | CSMA Carrier Sense | | Reference Signal | 75 | Enhanced CCE |
| | Multiple Access | | DN Data network | | ED Energy |
| 10 | CSMA/CA CSMA | | DNN Data Network | | Detection |
| | with collision | | Name | | EDGE Enhanced |
| | avoidance | 45 | DNAI Data Network | | Datarates for GSM |
| | CSS | | Access | 80 | Evolution |
| | Common | | Identifier | | (GSM Evolution) |
| 15 | Search Space, Cell- | | DRB Data Radio | | EAS Edge |
| | specific Search | | Bearer | | Application Server |
| | Space | | 50 DRS Discovery | | EASID Edge |
| | CTF Charging | | Reference Signal | 85 | Application Server |
| | Trigger Function | | DRX Discontinuous | | Identification |
| | CTS Clear-to-Send | | Reception | | ECS Edge |
| | 20 CW Codeword | | DSL Domain | | Configuration Server |
| | CWS Contention | 55 | Specific Language. | | ECSP Edge |
| | Window Size | | Digital | 90 | Computing Service |
| | D2D Device-to- | | Subscriber Line | | Provider |
| | Device | | DSLAM DSL | | EDN Edge |
| 25 | DC Dual | | Access Multiplexer | | Data Network |
| | Connectivity, Direct | 60 | DwPTS | | EEC Edge |
| | Current | | Downlink Pilot | 95 | Enabler Client |
| | DCI Downlink | | Time Slot | | EECID Edge |
| | Control | | E-LAN Ethernet | | Enabler Client |
| 30 | Information | | Local Area | | Identification |
| | DF | | Network | | EES |
| | Deployment | 65 | E2E | | Edge |
| | Flavour | | End-to-End | 100 | Enabler |
| | DL | | EAS Edge | | Server |
| | Downlink | | Application Server | | FACCH/F |
| | EESID Edge | | Physical | | Fast |
| | Enabler Server | | Downlink Control | 70 | Associated Control |
| | Identification | | Cannel | | CHannel |
| | EHE Edge | | EPRE Energy per | | FACCH/F Fast |
| 5 | Hosting Environment | 40 | resource element | | Associated Control |
| | EGMF Exposure | | EPS Evolved Packet | 75 | Channel/Full |
| | Governance | | System | | rate |
| | Management | | EREG enhanced REG, | | FACCH/H Fast |
| | Function | | enhanced resource | | Associated Control |
| 10 | EGPRS | | element groups | | Channel/Half |
| | Enhanced | 45 | ETSI European | | rate |
| | GPRS | | Telecommunications | 80 | FACH Forward Access |
| | EIR Equipment | | Standards | | Channel |
| | Identity Register | | Institute | | FAUSCH Fast |
| 15 | eLAA enhanced | 50 | ETWS Earthquake and | | Uplink Signalling |
| | Licensed Assisted | | Tsunami Warning | | Channel |
| | Access, | | System | 85 | FB Functional |
| | enhanced LAA | | eUICC embedded | | Block |
| | EM Element | | UICC, embedded | | FBI Feedback |
| 20 | Manager | 55 | Universal | | Information |
| | eMBB Enhanced | | Integrated Circuit | | FCC Federal |
| | Mobile | | Card | 90 | Communications |
| | Broadband | | E-UTRA Evolved | | Commission |
| | EMS Element | | UTRA | | FCCH Frequency |
| 25 | Management System | 60 | E-UTRAN Evolved | | Correction CHannel |
| | eNB evolved NodeB, | | UTRAN | | FDD Frequency |
| | E-UTRAN Node B | | EV2X Enhanced V2X | 95 | Division Duplex |
| | EN-DC E- | | F1AP F1 Application | | FDM Frequency |
| | UTRA-NR Dual | | Protocol | | Division |
| 30 | Connectivity | 65 | F1-C F1 Control | | Multiplex |
| | EPC Evolved Packet | | plane interface | | FDMA Frequency |
| | Core | | F1-U F1 | 100 | Division Multiple |
| | EPDCCH | | User plane | | Access |
| | enhanced | | interface | | FE Front |
| 35 | PDCCH, enhanced | | Sistema (Engl.: | | End |
| | FEC Forward Error | | Global | 70 | GTS Go To Sleep |
| | Correction | | Navigation | | Signal (related |
| | FFS For Further | | Satellite | | to WUS) |
| | Study | | System) | | GUMMEI Globally |
| 5 | FFT Fast Fourier | 40 | gNB Next | | Unique MME |
| | Transformation | | Generation NodeB | 75 | Identifier |
| | feLAA further | | gNB-CU gNB- | | GUTI Globally |
| | enhanced Licensed | | centralized unit, Next | | Unique Temporary |
| | Assisted | | Generation | | UE Identity |
| 10 | Access, further | 45 | NodeB | | HARQ Hybrid ARQ, |
| | enhanced LAA | | centralized unit | 80 | Hybrid |
| | FN Frame Number | | gNB-DU gNB- | | Automatic |
| | FPGA Field- | | distributed unit, Next | | Repeat Request |
| | Programmable Gate | | Generation | | HANDO Handover |
| 15 | Array | 50 | NodeB | | HFN HyperFrame |
| | FR Frequency | | distributed unit | 85 | Number |
| | Range | | GNSS Global | | HHO Hard Handover |
| | FQDN Fully | | Navigation Satellite | | HLR Home Location |
| | Qualified Domain | | System | | Register |
| 20 | Name | 55 | GPRS General Packet | | HN Home Network |
| | G-RNTI GERAN | | Radio Service | 90 | HO Handover |
| | Radio Network | | GPSI Generic | | HPLMN Home |
| | Temporary | | Public Subscription | | Public Land Mobile |
| | Identity | | Identifier | | Network |
| 25 | GERAN | 60 | GSM Global System | | HSDPA High |
| | GSM EDGE | | for Mobile | 95 | Speed Downlink |
| | RAN, GSM EDGE | | Communications, | | Packet Access |
| | Radio Access | | Groupe Special | | HSN Hopping |
| | Network | | Mobile | | Sequence Number |
| 30 | GGSN Gateway GPRS | 65 | GTP GPRS | | HSPA High Speed |
| | Support Node | | Tunneling Protocol | 100 | Packet Access |
| | GLONASS | | GTP-UGPRS | | HSS Home |
| | GLObal′naya | | Tunnelling | | Subscriber |
| | NAvigatsionnay | | Protocol | | Server |
| 35 | a Sputnikovaya | | for User Plane | | IoT |
| | HSUPA High | | IEI Information | | Internet of |
| | Speed Uplink Packet | | Element | | Things |
| | Access | | Identifier | | IP Internet |
| | HTTP Hyper Text | | IEIDL Information | | Protocol |
| 5 | Transfer Protocol | 40 | Element | 75 | Ipsec IP Security, |
| | HTTPS Hyper | | Identifier Data | | Internet Protocol |
| | Text Transfer Protocol | | Length | | Security |
| | Secure (https is | | IETF Internet | | IP-CAN IP- |
| | http/1.1 over | | Engineering Task | | Connectivity Access |
| 10 | SSL, i.e. port 443) | 45 | Force | 80 | Network |
| | I-Block | | IF Infrastructure | | IP-M IP Multicast |
| | Information | | IIOT Industrial | | IPv4 Internet |
| | Block | | Internet of Things | | Protocol Version 4 |
| | ICCID Integrated | | IM Interference | | IPv6 Internet |
| 15 | Circuit Card | 50 | Measurement, | 85 | Protocol Version 6 |
| | Identification | | Intermodulation, | | IR Infrared |
| | IAB Integrated | | IP Multimedia | | IS In Sync |
| | Access and | | IMC IMS | | IRP Integration |
| | Backhaul | | Credentials | | Reference Point |
| 20 | ICIC Inter-Cell | 55 | IMEI International | 90 | ISDN Integrated |
| | Interference | | Mobile | | Services Digital |
| | Coordination | | Equipment | | Network |
| | ID Identity, | | Identity | | ISIM IM Services |
| | identifier | 60 | IMGI International | | Identity Module |
| 25 | IDFT Inverse Discrete | | mobile group identity | 95 | ISO International |
| | Fourier | | IMPI IP Multimedia | | Organisation for |
| | Transform | | Private Identity | | Standardisation |
| | IE Information | | IMPU IP Multimedia | | ISP Internet Service |
| | element | | PUblic identity | | Provider |
| 30 | IBE In-Band | 65 | IMS IP Multimedia | 100 | IWF Interworking- |
| | Emission | | Subsystem | | Function |
| | IEEE Institute of | | IMSI International | | I-WLAN |
| | Electrical and | | Mobile | | Interworking |
| | Electronics | | Subscriber | | WLAN |
| 35 | Engineers | 70 | Identity | | LTE Long |
| | Constraint | | LAN Local Area | | Term |
| | length of the | | Network | | Evolution |
| | convolutional | | LADN Local | | M2M Machine-to- |
| | code, USIM | | Area Data Network | | Machine |
| 5 | Individual key | 40 | LBT Listen Before | 75 | MAC Medium Access |
| | kB Kilobyte (1000 | | Talk | | Control |
| | bytes) | | LCM LifeCycle | | (protocol |
| | kbps kilo-bits per | | Management | | layering context) |
| | second | | LCR Low Chip Rate | 80 | MAC Message |
| 10 | Kc Ciphering key | 45 | LCS Location | | authentication code |
| | Ki Individual | | Services | | (security/encryption |
| | subscriber | | LCID Logical | | context) |
| | authentication | | Channel ID | 85 | MAC-A MAC |
| | key | | LI Layer Indicator | | used for |
| 15 | KPI Key | 50 | LLC Logical Link | | authentication |
| | Performance Indicator | | Control, Low Layer | | and key |
| | KQI Key Quality | | Compatibility | | agreement |
| | Indicator | | LMF Location | | (TSG T WG3 context) |
| | KSI Key Set | | Management Function | 90 | MAC-IMAC used for |
| 20 | Identifier | 55 | LOS Line of | | data integrity of |
| | ksps kilo-symbols | | Sight | | signalling messages |
| | per second | | LPLMN Local | | (TSG T WG3 context) |
| | KVM Kernel Virtual | | PLMN | | MANO |
| | Machine | | LPP LTE | | Management |
| | 25 L1 Layer 1 | | 60 Positioning Protocol | | 95 and Orchestration |
| | (physical layer) | | LSB Least | | MBMS |
| | L1-RSRP Layer 1 | | Significant Bit | | Multimedia |
| | reference signal | | LTE Long Term | | Broadcast and |
| | received power | | Evolution | | Multicast |
| 30 | L2 Layer 2 (data | 65 | LWA LTE-WLAN | 100 | Service |
| | link layer) | | aggregation | | MBSFN |
| | L3 Layer 3 | | LWIP LTE/WLAN | | Multimedia |
| | (network layer) | | Radio Level | 105 | Broadcast |
| | LAA Licensed | | Integration with | | multicast |
| 35 | Assisted Access | 70 | IPsec Tunnel | | service Single |
| | Frequency | | 35 MIMO Multiple Input | 70 | MSB Most |
| | Network | | Multiple Output | | Significant Bit |
| | MCC Mobile Country | | MLC Mobile | | MSC Mobile |
| | Code | | Location Centre | | Switching Centre |
| 5 | MCG Master Cell | | MM Mobility | | MSI Minimum |
| | Group | 40 | Management | 75 | System |
| | MCOT Maximum | | MME Mobility | | Information, |
| | Channel | | Management Entity | | MCH Scheduling |
| | Occupancy | | MN Master Node | | Information |
| 10 | Time | | MNO Mobile | | MSID Mobile Station |
| | MCS Modulation and | 45 | Network Operator | 80 | Identifier |
| | coding scheme | | MO Measurement | | MSIN Mobile Station |
| | MDAF Management | | Object, Mobile | | Identification |
| | Data Analytics | | Originated | | Number |
| 15 | Function | | MPBCH MTC | | MSISDN Mobile |
| | MDAS Management | 50 | Physical Broadcast | 85 | Subscriber ISDN |
| | Data Analytics | | CHannel | | Number |
| | Service | | MPDCCH MTC | | MT Mobile |
| | MDT Minimization of | | Physical Downlink | | Terminated, Mobile |
| 20 | Drive Tests | | Control | | Termination |
| | ME Mobile | 55 | CHannel | 90 | MTC Machine-Type |
| | Equipment | | MPDSCH MTC | | Communications |
| | MeNB master eNB | | Physical Downlink | | MTLF Model |
| | MER Message Error | | Shared | | Training |
| 25 | Ratio | | CHannel | 95 | Logical |
| | MGL Measurement | 60 | MPRACH MTC | | Functions |
| | Gap Length | | Physical Random | | mMTCmassive MTC, |
| | MGRP Measurement | | Access | | massive |
| | Gap Repetition | | CHannel | | Machine-Type |
| 30 | Period | | MPUSCH MTC | | Communications |
| | MIB Master | 65 | Physical Uplink Shared | 100 | MU-MIMO |
| | Information Block, | | Channel | | Multi |
| | Management | | MPLS MultiProtocol | | User MIMO |
| | Information Base | | Label Switching | 70 | Physical |
| | MWUS MTC | | MS Mobile Station | | Random |
| | wake-up | 35 | NFVI NFV | | Access |
| | signal, MTC | | Infrastructure | | CHannel |
| | WUS | | NFVO NFV | | NPUSCH |
| | NACK Negative | | Orchestrator | | Narrowband |
| 5 | Acknowledgement | | NG Next | | Physical Uplink |
| | NAI Network | 40 | Generation, Next Gen | | Shared CHannel |
| | Access Identifier | | NGEN-DC NG- | 75 | NPSS Narrowband |
| | NAS Non-Access | | RAN E-UTRA-NR | | Primary |
| | Stratum, Non- Access | | Dual Connectivity | | Synchronization |
| 10 | Stratum layer | | NM Network | | Signal |
| | NCT Network | 45 | Manager | | NSSS Narrowband |
| | Connectivity | | NMS Network | 80 | Secondary |
| | Topology | | Management System | | Synchronization |
| 15 | NC-JT Non- | | N-POP Network Point | | Signal |
| | Coherent Joint | | of Presence | | NR New Radio, |
| | Transmission | 50 | NMIB, N-MIB | | Neighbour Relation |
| | NEC Network | | Narrowband MIB | 85 | NRF NF Repository |
| | Capability | | NPBCH | | Function |
| | Exposure | | Narrowband | | NRS Narrowband |
| 20 | NE-DC NR-E- | | Physical | | Reference Signal |
| | UTRA Dual | 55 | Broadcast | | NS Network |
| | Connectivity | | CHannel | 90 | Service |
| | NEF Network | | NPDCCH | | NSA Non-Standalone |
| | Exposure Function | | Narrowband | | operation mode |
| 25 | NF Network | | Physical | | NSD Network |
| | Function | 60 | Downlink | | Service Descriptor |
| | NFP Network | | Control CHannel | 95 | NSR Network |
| | Forwarding Path | | NPDSCH | | Service Record |
| | NFPD Network | | Narrowband | | NSSAINetwork Slice |
| 30 | Forwarding Path | | Physical | | Selection |
| | Descriptor | 65 | Downlink | | Assistance |
| | NFV Network | | Shared CHannel | 100 | Information |
| | Functions | | NPRACH | | S-NNSAI Single- |
| | Virtualization | | Narrowband | | NSSAI |
| | NSSF Network Slice | | PAR Peak to | | PDN Packet Data |
| | Selection Function | | Average Ratio | | Network, Public |
| | NW Network | | PBCH Physical | | Data Network |
| | NWDAF Network | | Broadcast Channel | | PDSCH Physical |
| 5 | Data Analytics | 40 | PC Power Control, | 75 | Downlink Shared |
| | Function | | Personal | | Channel |
| | NWUSNarrowband | | Computer | | PDU Protocol Data |
| | wake-up signal, | | PCC Primary | | Unit |
| | Narrowband WUS | | Component Carrier, | | PEI Permanent |
| 10 | NZP Non-Zero | 45 | Primary CC | 80 | Equipment |
| | Power | | P-CSCF Proxy | | Identifiers |
| | O&M Operation and | | CSCF | | PFD Packet Flow |
| | Maintenance | | PCell Primary Cell | | Description |
| | ODU2 Optical channel | | PCI Physical Cell | | P-GW PDN Gateway |
| | 15 Data Unit-type 2 | 50 | ID, Physical Cell | 85 | PHICH Physical |
| | OFDM Orthogonal | | Identity | | hybrid-ARQ indicator |
| | Frequency Division | | PCEF Policy and | | channel |
| | Multiplexing | | Charging | | PHY Physical layer |
| | OFDMA | | Enforcement | | PLMN Public Land |
| 20 | Orthogonal | 55 | Function | 90 | Mobile Network |
| | Frequency Division | | PCF Policy Control | | PIN Personal |
| | Multiple Access | | Function | | Identification Number |
| | OOB Out-of-band | | PCRF Policy Control | | PM Performance |
| | OOS Out of | | and Charging Rules | | Measurement |
| 25 | Sync | 60 | Function | 95 | PMI Precoding |
| | OPEX OPerating | | PDCP Packet Data | | Matrix Indicator |
| | EXpense | | Convergence | | PNF Physical |
| | OSI Other System | | Protocol, Packet | | Network Function |
| | Information | | Data Convergence | | PNFD Physical |
| 30 | OSS Operations | 65 | Protocol layer | 100 | Network Function |
| | Support System | | PDCCH Physical | | Descriptor |
| | OTA over-the-air | | Downlink Control | | PNFR Physical |
| | PAPR Peak-to- | | Channel | | Network |
| | Average Power | | PDCP Packet Data | | Function |
| 35 | Ratio | 70 | Convergence Protocol | | Record |
| | POC PTT over | 35 | PSFCH physical | 70 | RA-RNTI Random |
| | Cellular | | sidelink feedback | | Access RNTI |
| | PP, PTP Point-to- | | channel | | RAB Radio Access |
| | Point | | PSCell Primary SCell | | Bearer, Random |
| 5 | PPP Point-to-Point | | PSS Primary | | Access Burst |
| | Protocol | 40 | Synchronization | 75 | RACH Random Access |
| | PRACH Physical | | Signal | | Channel |
| | RACH | | PSTN Public Switched | | RADIUS Remote |
| | PRB Physical | | Telephone Network | | Authentication Dial |
| 10 | resource block | | PT-RS Phase-tracking | | In User Service |
| | PRG Physical | 45 | reference signal | 80 | RAN Radio Access |
| | resource block | | PTT Push-to-Talk | | Network |
| | group | | PUCCH Physical | | RAND RANDom |
| | ProSe Proximity | | Uplink Control | | number (used for |
| 15 | Services, | | Channel | | authentication) |
| | Proximity- | 50 | PUSCH Physical | 85 | RAR Random Access |
| | Based Service | | Uplink Shared | | Response |
| | PRS Positioning | | Channel | | RAT Radio Access |
| | Reference Signal | | QAM Quadrature | | Technology |
| 20 | PRR Packet | | Amplitude | | RAU Routing Area |
| | Reception Radio | 55 | Modulation | 90 | Update |
| | PS Packet Services | | QCI QoS class of | | RB Resource block, |
| | PSBCH Physical | | identifier | | Radio Bearer |
| | Sidelink Broadcast | | QCL Quasi co- | | RBG Resource block |
| 25 | Channel | | location | | group |
| | PSDCH Physical | 60 | QFI QoS Flow ID, | 95 | REG Resource |
| | Sidelink Downlink | | QoS Flow | | Element Group |
| | Channel | | Identifier | | Rel Release |
| | PSCCH Physical | | QoS Quality of | | REQ REQuest |
| 30 | Sidelink Control | | Service | | RF Radio |
| | Channel | 65 | QPSK Quadrature | 100 | Frequency |
| | PSSCH Physical | | (Quaternary) Phase | | RI Rank Indicator |
| | Sidelink Shared | | Shift Keying | | RIV Resource |
| | Channel | | QZSS Quasi-Zenith | | indicator value |
| | RLC | | Satellite System | | RL Radio Link |
| | Radio Link | | RRC Radio Resource | 70 | S-CSCF serving |
| | Control, Radio | | Control, Radio | | CSCF |
| | Link Control | | Resource Control | | S-GW Serving |
| | layer | | layer | | Gateway |
| 5 | RLC AM RLC | 40 | RRM Radio Resource | | S-RNTI SRNC |
| | Acknowledged Mode | | Management | 75 | Radio Network |
| | RLC UM RLC | | RS Reference | | Temporary |
| | Unacknowledged | | Signal | | Identity |
| | Mode | | RSRP Reference | | S-TMSI SAE |
| 10 | RLF Radio Link | 45 | Signal Received | | Temporary Mobile |
| | Failure | | Power | 80 | Station |
| | RLM Radio Link | | RSRQ Reference | | Identifier |
| | Monitoring | | Signal Received | | SA Standalone |
| | RLM-RS | | Quality | | operation mode |
| 15 | Reference | 50 | RSSI Received Signal | | SAE System |
| | Signal for RLM | | Strength | 85 | Architecture |
| | RM Registration | | Indicator | | Evolution |
| | Management | | RSU Road Side Unit | | SAP Service Access |
| | RMC Reference | | RSTD Reference | | Point |
| 20 | Measurement Channel | 55 | Signal Time | | SAPD Service Access |
| | RMSI Remaining | | difference | 90 | Point Descriptor |
| | MSI, Remaining | | RTP Real Time | | SAPI Service Access |
| | Minimum | | Protocol | | Point Identifier |
| | System | | RTS Ready-To-Send | | SCC Secondary |
| | 25 Information | 60 | RTT Round Trip | | Component Carrier, |
| | RN Relay Node | | Time | 95 | Secondary CC |
| | RNC Radio Network | | Rx Reception, | | SCell Secondary Cell |
| | Controller | | Receiving, Receiver | | SCEF Service |
| | RNL Radio Network | | S1AP S1 Application | | Capability Exposure |
| 30 | Layer | 65 | Protocol | | Function |
| | RNTI Radio Network | | S1-MME S1 for | 100 | SC-FDMA Single |
| | Temporary | | the control plane | | Carrier Frequency |
| | Identifier | | S1-U S1 for | | Division |
| | ROHC RObust Header | | the user | | Multiple |
| 35 | Compression | | plane | | Access |
| | SCG Secondary Cell | | 35 SFI Slot format | 70 | SMSF |
| | Group | | indication | | SMTC SSB-based |
| | SCM Security | | SFTD Space- | | Measurement Timing |
| | Context | | Frequency Time | | Configuration |
| 5 | Management | | Diversity, SFN | | SN Secondary |
| | SCS Subcarrier | 40 | and frame timing | 75 | Node, Sequence |
| | Spacing | | difference | | Number |
| | SCTP Stream Control | | SFN System Frame | | SoC System on Chip |
| | Transmission | | Number | | SON Self-Organizing |
| 10 | Protocol | | SgNB Secondary gNB | | Network |
| | SDAP Service Data | 45 | SGSN Serving GPRS | 80 | SpCell Special Cell |
| | Adaptation | | Support Node | | SP-CSI-RNTISemi- |
| | Protocol, | | S-GW Serving | | Persistent CSI RNTI |
| | Service Data | | Gateway | | SPS Semi-Persistent |
| 15 | Adaptation | | SI System | | Scheduling |
| | Protocol layer | 50 | Information | 85 | SQN Sequence |
| | SDL Supplementary | | SI-RNTI System | | number |
| | Downlink | | Information RNTI | | SR Scheduling |
| | SDNF Structured Data | | SIB System | | Request |
| 20 | Storage Network | | Information Block | | SRB Signalling |
| | Function | 55 | SIM Subscriber | 90 | Radio Bearer |
| | SDP Session | | Identity Module | | SRS Sounding |
| | Description Protocol | | SIP Session | | Reference Signal |
| | SDSF Structured Data | | Initiated Protocol | | SS Synchronization |
| 25 | Storage Function | | SiP System in | | Signal |
| | SDT Small Data | 60 | Package | 95 | SSB Synchronization |
| | Transmission | | SL Sidelink | | Signal Block |
| | SDU Service Data | | SLA Service Level | | SSID Service Set |
| | Unit | | Agreement | | Identifier |
| 30 | SEAF Security | | SM Session | | SS/PBCH Block |
| | Anchor Function | 65 | Management | 100 | SSBRI SS/PBCH |
| | SeNB secondary eNB | | SMF Session | | Block Resource |
| | SEPP Security Edge | | Management Function | | Indicator, |
| | Protection | | SMS Short Message | | Synchronization |
| | Proxy | | Service | | Signal Block |
| | Resource | | TA Timing | 70 | TMSI Temporary |
| | Indicator | | Advance, Tracking | | Mobile |
| | SSC Session and | | Area | | Subscriber |
| | Service | | TAC Tracking Area | | Identity |
| 5 | Continuity | 40 | Code | | TNL Transport |
| | SS-RSRP | | TAG Timing | 75 | Network Layer |
| | Synchronization | | Advance Group | | TPC Transmit Power |
| | Signal based | | TAI | | Control |
| | Reference | | Tracking Area | | TPMI Transmitted |
| 10 | Signal Received | 45 | Identity | | Precoding Matrix |
| | Power | | TAU Tracking Area | 80 | Indicator |
| | SS-RSRQ | | Update | | TR Technical |
| | Synchronization | | TB Transport Block | | Report |
| | Signal based | | TBS Transport Block | | TRP, TRxP |
| 15 | Reference | 50 | Size | | Transmission |
| | Signal Received | | TBD To Be Defined | 85 | Reception Point |
| | Quality | | TCI Transmission | | TRS Tracking |
| | SS-SINR | | Configuration | | Reference Signal |
| | Synchronization | | Indicator | | TRx Transceiver |
| 20 | Signal based Signal | 55 | TCP Transmission | | TS Technical |
| | to Noise and | | Communication | 90 | Specifications, |
| | Interference Ratio | | Protocol | | Technical |
| | SSS Secondary | | TDD Time Division | | Standard |
| | Synchronization | | Duplex | | TTI Transmission |
| 25 | Signal | 60 | TDM Time Division | | Time Interval |
| | SSSG Search Space | | Multiplexing | 95 | Tx Transmission, |
| | Set Group | | TDMA Time Division | | Transmitting, |
| | SSSIF Search Space | | Multiple Access | | Transmitter |
| | Set Indicator | | TE Terminal | | U-RNTI UTRAN |
| 30 | SST Slice/Service | 65 | Equipment | | Radio Network |
| | Types | | TEID Tunnel End | 100 | Temporary |
| | SU-MIMO Single | | Point Identifier | | Identity |
| | User MIMO | | TFT Traffic | | UART |
| | SUL Supplementary | | Flow | | Universal |
| 35 | Uplink | | Template | | Asynchronous |
| | Receiver and | | USB Universal Serial | | VNFFG VNF |
| | Transmitter | | Bus | | Forwarding Graph |
| | UCI Uplink Control | | USIM Universal | | VNFFGD VNF |
| | Information | | Subscriber Identity | | Forwarding Graph |
| 5 | UE User Equipment | 40 | Module | 75 | Descriptor |
| | UDM Unified Data | | USS UE-specific | | VNFM VNF Manager |
| | Management | | search space | | VOIP Voice-over-IP, |
| | UDP User Datagram | | UTRA UMTS | | Voice-over- Internet |
| | Protocol | | Terrestrial Radio | | Protocol |
| 10 | UDSF Unstructured | 45 | Access | 80 | VPLMN Visited |
| | Data Storage Network | | UTRAN | | Public Land Mobile |
| | Function | | Universal | | Network |
| | UICC Universal | | Terrestrial Radio | | VPN Virtual Private |
| | Integrated Circuit | | Access | | Network |
| 15 | Card | 50 | Network | 85 | VRB Virtual |
| | UL Uplink | | UwPTS Uplink | | Resource Block |
| | UM | | Pilot Time Slot | | WiMAX |
| | Unacknowledged | | V2I Vehicle-to- | | Worldwide |
| | Mode | | Infrastruction | 90 | Interoperability |
| 20 | UML Unified | 55 | V2P Vehicle-to- | | for Microwave |
| | Modelling Language | | Pedestrian | | Access |
| | UMTS Universal | | V2V Vehicle-to- | | WLANWireless Local |
| | Mobile | | Vehicle | | Area Network |
| 25 | Telecommunications | 60 | V2X Vehicle-to- | | WMAN Wireless |
| | System | | everything | 95 | Metropolitan Area |
| | UP User Plane | | VIM Virtualized | | Network |
| | UPF User Plane | | Infrastructure Manager | | WPANWireless |
| | Function | | VL Virtual Link, | | Personal Area Network |
| | URI Uniform | | VLAN Virtual LAN, | 100 | X2-C X2-Control |
| 30 | Resource Identifier | 65 | Virtual Local Area | | plane |
| | URL Uniform | | Network | | X2-U X2-User plane |
| | Resource Locator | | VM Virtual | | XML extensible |
| | URLLC Ultra- | | Machine | | Markup |
| | Reliable and Low | | VNF Virtualized | | Language |
| 35 | Latency | 70 | Network Function | | |
| | XRES EXpected user | | | | |
| | RESponse | | | | |
| | XOR exclusive OR | | | | |
| | ZC Zadoff-Chu | | | | |
| 5 | ZP Zero Power | | | | |

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1-20. (canceled)

21. A user equipment (UE) comprising:
memory to store an indication related to transmission or reception activity of a cell of a cellular network during a non-active duration of the cell that is related to cell discontinuous transmission (DTX) or cell discontinuous reception (DRX); and
one or more processors configured to facilitate monitoring, based on the indication, for receipt of a signal.

22. The UE of claim 21, wherein the indication is received via higher-layer signaling.

23. The UE of claim 22, wherein the higher-layer signaling is radio resource control (RRC) signaling or layer 1/layer 2 (L1/L2) signaling.

24. The UE of claim 21, wherein the indication relates to transmission or reception activity of a plurality of cells, and wherein the plurality of cells have a same configuration of cell DTX or cell DRX.

25. The UE of claim 21, wherein the monitoring for receipt of the signal relates to physical downlink control channel (PDCCH) monitoring.

26. The UE of claim 21, wherein the monitoring for receipt of the signal relates to receipt of a reference signal.

27. The UE of claim 21, wherein the one or more processors are further configured to cause the UE to:
identify, during the non-active duration, that the UE is configured with UE DRX operation during the non-active duration;
act, during the non-active duration, in accordance with cell DTX or cell DRX; and
not act, during the non-active duration, in accordance with the UE DRX operation.

28. One or more non-transitory computer-readable media comprising instructions that, upon execution of the instructions by one or more processors, are to cause a base station of a cellular network to:
generate an indication related to transmission or reception activity of a cell of a cellular network during a non-active duration of the cell that is related to cell discontinuous transmission (DTX) or cell discontinuous reception (DRX); and
transmit, to a user equipment (UE) of the cellular network, the indication, wherein the UE is configured to monitor, based on the indication, for receipt of a signal.

29. The one or more non-transitory computer-readable media of claim 28, wherein the indication is transmitted via higher-layer signaling.

30. The one or more non-transitory computer-readable media of claim 29, wherein the higher-layer signaling is radio resource control (RRC) signaling or layer 1/layer 2 (L1/L2) signaling.

31. The one or more non-transitory computer-readable media of claim 28, wherein the indication relates to transmission or reception activity of a plurality of cells, and wherein the plurality of cells have a same configuration of cell DTX or cell DRX.

32. The one or more non-transitory computer-readable media of claim 28, wherein the monitoring for receipt of the signal relates to physical downlink control channel (PDCCH) monitoring.

33. The one or more non-transitory computer-readable media of claim 28, wherein monitoring for receipt of the signal relates to receipt of a reference signal.

34. A user equipment (UE) comprising:
one or more processors; and
one or more non-transitory computer-readable media comprising instructions that, upon execution of the instructions by the one or more processors, are to cause the UE to:
identify an indication related to transmission or reception activity of a cell of a cellular network during a non-active duration of the cell that is related to cell discontinuous transmission (DTX) or cell discontinuous reception (DRX); and
monitor, based on the indication, for receipt of a signal.

35. The UE of claim 34, wherein the indication is received via higher-layer signaling.

36. The UE of claim 35, wherein the higher-layer signaling is radio resource control (RRC) signaling or layer 1/layer 2 (L1/L2) signaling.

37. The UE of claim 34, wherein the indication relates to transmission or reception activity of a plurality of cells, and wherein the plurality of cells have a same configuration of cell DTX or cell DRX.

38. The UE of claim 34, wherein the monitoring for receipt of the signal relates to physical downlink control channel (PDCCH) monitoring.

39. The UE of claim 34, wherein the monitoring for receipt of the signal relates to receipt of a reference signal.

40. The UE of claim 34, wherein the instructions are further to cause the UE to:
identify, during the non-active duration, that the UE is configured with UE DRX operation during the non-active duration;
act, during the non-active duration, in accordance with cell DTX or cell DRX; and
not act, during the non-active duration, in accordance with the UE DRX operation.
